(19) United States
(12) Patent Application Publication
(10) Pub. No.: US 2026/0132257 A1
(43) Pub. Date: May 14, 2026

(54) OPEN-CAGE BENZOCYCLOBUTENYL POLYHEDRAL OLIGOMERIC SILSESQUIOXANE, CURED MATERIAL, AND PREPARATION METHODS AND USE THEREOF

(71) Applicant: Xi'an Besti New Material Technology Co., Ltd., Xi'an City (CN)

(72) Inventors: Xiaoyan MA, Xi'an City (CN); Zongwu ZHANG, Xi'an City (CN); Xutao MA, Xi'an City (CN)

(21) Appl. No.: 19/388,267

(22) Filed: Nov. 13, 2025

(30) Foreign Application Priority Data
Nov. 13, 2024 (CN) 202411617076.9

(51) Int. Cl. C08G 77/04; C08G 77/00

(52) U.S. Cl. CPC C08G 77/045; C08G 77/80

(57) ABSTRACT

An open-cage benzocyclobutenyl polyhedral oligomeric silsesquioxane, a cured material, and preparation methods and use thereof are provided, belonging to the technical field of organic-inorganic thermosetting resins. The open-cage benzocyclobutenyl polyhedral oligomeric silsesquioxane has a structural formula shown in formula 1 or formula 2. The cured material based on the open-cage benzocyclobutenyl polyhedral oligomeric silsesquioxane possesses an ultra-low dielectric constant and low dielectric loss, and also exhibits high heat resistance and desirable flexibility. The thermosetting resin can not only be prepared into robust bulk materials by casting, but also be formed into flexible thermosetting resin films by spin-coating or drop-coating.

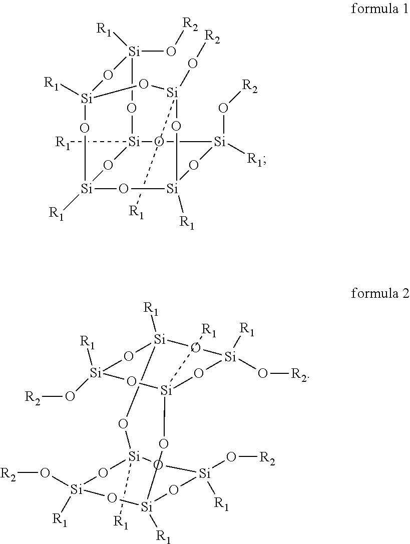

### CROSS REFERENCE TO RELATED APPLICATION

This patent application claims the benefit and priority of Chinese Patent Application No. 202411617076.9, entitled “Open-cage benzocyclobutenyl polyhedral oligomeric silsesquioxane thermosetting resin, and preparation method and use thereof” filed on Nov. 13, 2024, the disclosure of which is incorporated by reference herein in its entirety as part of the present application.

### TECHNICAL FIELD

The present disclosure pertains to the technical field of organic-inorganic thermosetting resin materials, and specifically provides an open-cage benzocyclobutenyl polyhedral oligomeric silsesquioxane thermosetting resin, and a preparation method and use thereof.

### BACKGROUND

The rapid advancement of the Internet of Things (IoT) and high-frequency (5G) communication technologies has imposed higher requirements on the high integration and efficient signal transmission of electronic devices. This results in more functional circuits being compressed into smaller spaces, leading to increased device capacitance and resistance, which in turn causes issues such as crosstalk noise, signal delay, and power consumption. Signal transmission losses in digital circuits primarily stem from conductor loss (T_{LC}) and dielectric loss (T_{LD}). Dielectric loss (T_{LD}) is closely related to the dielectric constant (k) and dielectric loss tangent (tan δ) of the dielectric material, following the equation:

$${T}_{Ld} = K \times \frac{f}{c} \times {ε}^{0.5} \times tan δ$$

where K represents a constant, f represents frequency, and c represents the speed of light. Therefore, there is an urgent need to develop insulating materials with low dielectric constants and low dielectric loss to meet the rapid development of electronic communication technologies. Additionally, it is desirable for the developed dielectric materials to exhibit excellent thermal stability to withstand post-processing at a high temperature of 350° C., as well as appropriate flexibility to meet the requirements for the fabrication and development of flexible electronic components. In summary, the development of insulating materials with low dielectric constants and low dielectric losses, good thermal stability, and appropriate flexibility is of great significance for advancing the electrical communication industry.

Polyhedral oligomeric silsesquioxane (POSS) is a type of soluble, meltable intramolecular organic-inorganic hybrid nanomolecule, which is composed of a hollow inorganic structure constructed from Si—O bonds, as well as organic groups (R) consisting of carbon and hydrogen. The hollow inorganic structure of POSS has a high free volume fraction, making it an ideal building block for low dielectric constant materials; and organic components thereof are highly designable, allowing it to be widely used as a nanofiller to modify resin matrices such as epoxy resins, bismaleimide resins, and cyanate ester resins. However, due to the inherent polarity differences between POSS and the resin materials, POSS inevitably forms molecular clusters in the resin matrix at high addition levels, creating numerous heterogeneous interfaces and leading to interfacial polarization in the composite materials. This is detrimental to further reducing the dielectric constant and loss of the resin. Related technology discloses a thermosetting material based on self-crosslinking of closed-cage benzocyclobutenyl POSS (T₈), which avoids the compatibility issues of traditional modification methods and achieves uniform dispersion of a large number of hollow cage structures in the resin matrix. The prepared material exhibits low dielectric properties (around 2.2). However, the overly rigid closed-cage T₈ structure and ultra-high functionality (=8) result in brittle cured products, making it difficult for practical applications.

### SUMMARY

In view of this, an objective of the present disclosure is to provide an open-cage benzocyclobutenyl polyhedral oligomeric silsesquioxane (POSS), a cured material, and preparation methods and use thereof. In the present disclosure, the cured material prepared by crosslinking and curing the open-cage benzocyclobutenyl polyhedral oligomeric silsesquioxane exhibits desirable flexibility, an ultra-low dielectric constant, low dielectric loss, excellent thermal stability, and high heat resistance.

The present disclosure provides an open-cage benzocyclobutenyl polyhedral oligomeric silsesquioxane, having a structural formula shown in formula 1 or formula 2:

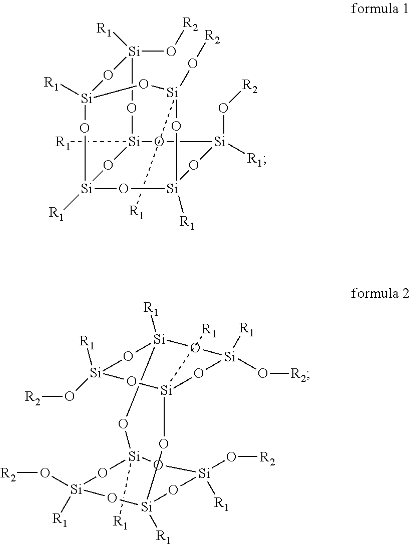

where in the formula 1 and the formula 2,
R₁ is selected from the group consisting of phenyl, cyclohexyl, n-pentyl, trifluoro-n-pentyl, and methyl;
R₂ is selected from the group consisting of

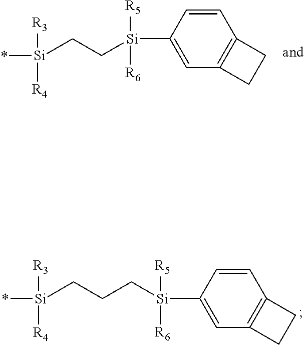

and
R₃, R₄, R₅, and R₆ each are independently selected from the group consisting of H, alkyl, cycloalkyl, cycloalkoxy, alkylthio, alkylamino, alkenylamino, aryl, heteroaryl, substituted alkyl, substituted cycloalkyl, substituted cycloalkoxy, substituted alkylthio, substituted alkylamino, substituted alkenylamino, substituted aryl, and substituted heteroaryl.

In some embodiments, for R₃, R₄, R₅, and R₆, the alkyl is C₁-C₆ alkyl, the cycloalkyl is C₃-C₆ cycloalkyl, the cycloalkoxy is 3- to 7-membered cycloalkoxy, the alkylthio is C₁-C₆ alkylthio, the alkylamino is C₁-C₆ alkylamino, the alkenylamino is C₂-C₆ alkenylamino, the aryl is C₆-C₁₂ aryl, the aryl includes benzo C₃-C₆ cycloalkyl, the heteroaryl is 5- to 12-membered heteroaryl, the 5- to 12-membered heteroaryl has 1 to 3 heteroatoms selected from the group consisting of N, O, and S, and the heteroaryl includes a benzo 5- to 6-membered heterocyclic group.

In some embodiments, the open-cage benzocyclobutenyl polyhedral oligomeric silsesquioxane has a structural formula shown in formula 3 or formula 4:

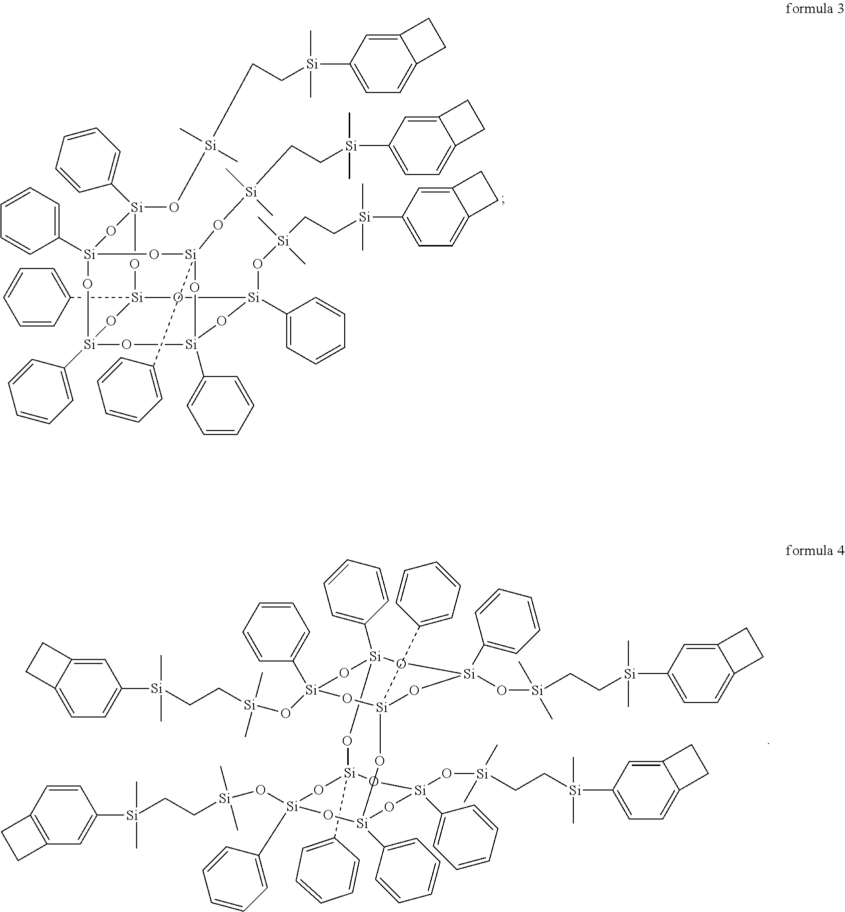

The present disclosure further provides a method for preparing the open-cage benzocyclobutenyl polyhedral oligomeric silsesquioxane, including the following steps:
mixing a trialkoxysilane coupling agent, an alkali metal hydroxide, water, and a first organic solvent, and conducting reaction under reflux to obtain an open-cage silanol alkali metal salt polyhedral oligomeric silsesquioxane;
mixing the open-cage silanol alkali metal salt polyhedral oligomeric silsesquioxane (herein also named as the open-cage silanol alkali metal salt polysilsesquioxane), vinyl chlorosilane, a first catalyst, and a second organic solvent, and conducting etherification to obtain a vinyl open-cage polyhedral oligomeric silsesquioxane; and
mixing the vinyl open-cage polyhedral oligomeric silsesquioxane, a benzocyclobutenyl silane compound, a second catalyst, and a third organic solvent, and conducting hydrosilylation to obtain the open-cage benzocyclobutenyl polyhedral oligomeric silsesquioxane; where
the trialkoxysilane coupling agent, the vinyl chlorosilane, and the benzocyclobutenyl silane compound have structural formulas shown in formula 5, formula 6, formula 6-1, and formula 7, respectively:

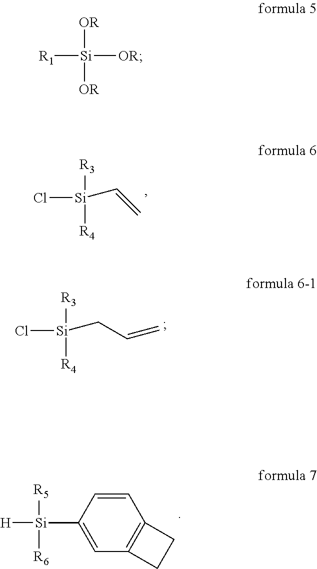

In some embodiments, alkoxy in the trialkoxysilane coupling agent is selected from the group consisting of methoxy and ethoxy.

In some embodiments, a molar ratio of the alkali metal hydroxide to the trialkoxysilane coupling agent is in a range of 1:1.5 to 1:3.

In some embodiments, a molar ratio of an alkali metal element in the open-cage silanol alkali metal salt polyhedral oligomeric silsesquioxane to the vinyl chlorosilane is in a range of 1:2 to 1:4.

In some embodiments, a molar ratio of vinyl in the vinyl open-cage polyhedral oligomeric silsesquioxane to the benzocyclobutenyl silane compound is in a range of 1:1 to 1:1.5.

The present disclosure further provides use of the open-cage benzocyclobutenyl polyhedral oligomeric silsesquioxane or the open-cage benzocyclobutenyl polyhedral oligomeric silsesquioxane prepared by the method in the field of electrical communications.

The present disclosure further provides a cured material, where the cured material is obtained by crosslinking and curing the open-cage benzocyclobutenyl polyhedral oligomeric silsesquioxane as described in above technical solutions or the open-cage benzocyclobutenyl polyhedral oligomeric silsesquioxane prepared by the method as described above.

The present disclosure further provides use of the cured material as described in above technical solutions in the field of electrical communications.

Compared with the prior art, embodiments of the present disclosure have the following beneficial effects:

The present disclosure provides an open-cage benzocyclobutenyl polyhedral oligomeric silsesquioxane, having a structural formula shown in formula 1 or formula 2:

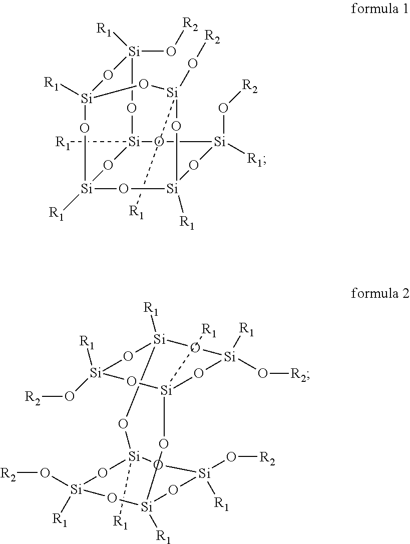

where in the formula 1 and the formula 2,
R₁ is selected from the group consisting of phenyl, cyclohexyl, n-pentyl, trifluoro-n-pentyl, and methyl;
R₂ is selected from the group consisting of

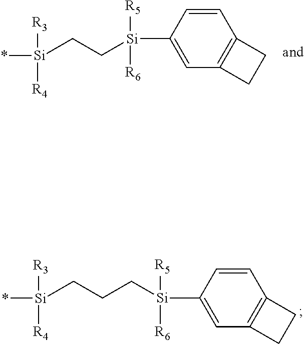

and
R₃, R₄, R₅, and R₆ each are independently selected from the group consisting of H, alkyl, cycloalkyl, cycloalkoxy, alkylthio, alkylamino, alkenylamino, aryl, heteroaryl, substituted alkyl, substituted cycloalkyl, substituted cycloalkoxy, substituted alkylthio, substituted alkylamino, substituted alkenylamino, substituted aryl, and substituted heteroaryl.

In the present disclosure, the open-cage benzocyclobutenyl polyhedral oligomeric silsesquioxane (POSS), herein also named as the open-cage benzocyclobutenyl polysilsesquioxane, possesses a larger outward-expanded cage-like inorganic hollow structure, which facilitates its cured material obtained by self-crosslinking with high heat-resistance to exhibit ultra-low dielectric constant, thereby breaking through the current dilemma faced by ultra-low dielectric constant materials. Moreover, owing to the limited number of derivatization sites provided by its unique structure, the open-cage benzocyclobutenyl POSS can be precisely functionalized with only 3 or 4 reactive organic groups that participate in the curing process, which effectively mitigates the issue of excessive crosslinking commonly encountered in the curing of high-functionality closed-cage POSS. An inorganic cage structure is appropriately opened in an open-cage POSS, resulting in a moderately reduced rigidity compared with closed-cage POSS, and thus it facilitates the cured material prepared from the open-cage POSS to form flexible thermosetting films. Consequently, in the present disclosure, by utilizing the open-cage benzocyclobutenyl POSS to prepare a molecule-level homogeneous hybrid organic-inorganic thermosetting resin via thermal self-crosslinking achieves a unification of low dielectric properties, heat resistance, and flexibility in a thermosetting material. The resin of the present disclosure can not only be thermally cured to form bulk materials with low dielectric constant and dielectric loss, but also can be prepared into flexible films, meeting the demands for ultra-low dielectric constant materials in specific thin-film applications. This holds significant importance for the field of wireless communications, including 5G electronic packaging, printed circuit boards, radomes, and others.

Data from examples indicate that the cured material prepared by the open-cage benzocyclobutenyl POSS-based thermosetting resin of the present disclosure exhibits an ultra-low dielectric constant and low dielectric loss at a frequency of 1 MHz, and also exhibits high heat resistance and desirable flexibility, which can not only be prepared into robust bulk materials by casting, but also be prepared into flexible thermosetting films by spin-coating or drop-coating. In the present disclosure, by using POSS with an open-cage configuration as a monomer, a resultant thermal self-cured product thereof is intramolecular organic-inorganic hybridized and thermosetting, which overcomes issues commonly encountered in POSS-modified polymers, such as uneven dispersion of POSS, low addition threshold, and limited improvement in material properties.

### BRIEF DESCRIPTION OF THE DRAWINGS

To describe the technical solutions in examples of the present disclosure or in the prior art more clearly, the accompanying drawings required for the examples are briefly described below. Apparently, the accompanying drawings in the following description show merely some examples of the present disclosure, and those of ordinary skill in the art may still derive other accompanying drawings from these accompanying drawings without creative efforts.

FIG. 1A to FIG. 1C show ¹H (FIG. 1A), ¹³C (FIG. 1), ²⁹Si (FIG. 1C) nuclear magnetic resonance (NMR) spectral data of OP₁B₃—POSS, where the OP₁B₃—POSS has a structure of

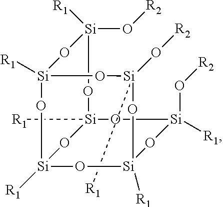

with definitions of R₁ and R₂ shown in FIG. 1A to FIG. 1C;

FIG. 2A to FIG. 2C show ¹H (FIG. 2A), ¹³C (FIG. 2B), ²⁹Si (FIG. 2C) NMR spectral data of OP₂B₄—POSS, where the OP₂B₄—POSS has a structure of

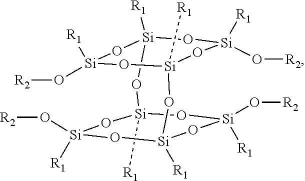

with definitions of R₁ and R₂ shown in FIG. 2A to FIG. 2C;

FIG. 3A to FIG. 3C show ¹H (FIG. 3A), ¹³C (FIG. 3B), ²⁹Si (FIG. 3C) NMR spectral data of OP₀B₈—POSS, where the OP₀B₈—POSS has a structure of

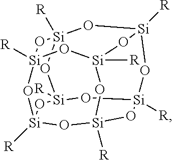

with definition of R shown in FIG. 3A to FIG. 3C;

FIG. 4A to FIG. 4C show ¹H (FIG. 4A), ¹³C (FIG. 4B), ²⁹Si (FIG. 4C) NMR spectral data of OP₀B₄T₄-POSS, where the OP₀B₄T₄-POSS has a structure of

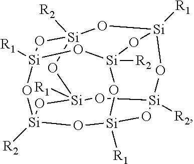

with definitions of R₁ and R₂ shown in FIG. 4A to FIG. 4C;

FIG. 5 shows broadband dielectric constant data of the open-cage benzocyclobutenyl POSS resin and comparative example resins;

FIG. 6 shows broadband dielectric loss data of the open-cage benzocyclobutenyl POSS resin and comparative example resins;

FIG. 7 shows thermogravimetric curves of the open-cage benzocyclobutenyl POSS resin and comparative example resins;

FIG. 8 shows Young's modulus data of the open-cage benzocyclobutenyl POSS resin and comparative example resins; and

### DETAILED DESCRIPTION OF THE EMBODIMENTS

The present disclosure provides an open-cage benzocyclobutenyl polyhedral oligomeric silsesquioxane (POSS), having a structural formula shown in formula 1 or formula 2:

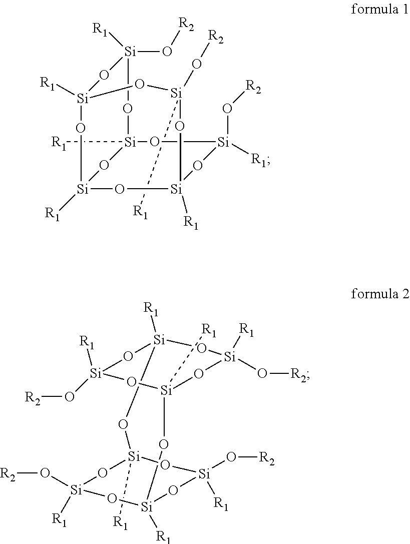

where in the formula 1 and the formula 2,
R₁ is selected from the group consisting of phenyl, cyclohexyl, n-pentyl, trifluoro-n-pentyl, and methyl;
R₂ is selected from the group consisting of and

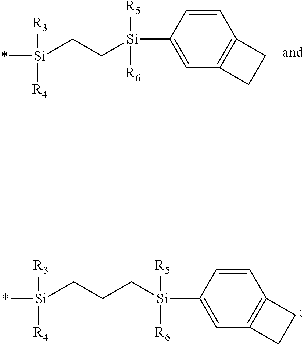

and
R₃, R₄, R₅, and R₆ each are independently selected from the group consisting of H, alkyl, cycloalkyl, cycloalkoxy, alkylthio, alkylamino, alkenylamino, aryl, heteroaryl, substituted alkyl, substituted cycloalkyl, substituted cycloalkoxy, substituted alkylthio, substituted alkylamino, substituted alkenylamino, substituted aryl, and substituted heteroaryl.

In the present disclosure, “*” represents a connection site.

In the present disclosure, R₁ is an inert organic structure of POSS; phenyl, cyclohexyl, trifluoro-n-pentyl, n-pentyl, or methyl are shown below, respectively; and R₁ is preferably phenyl;

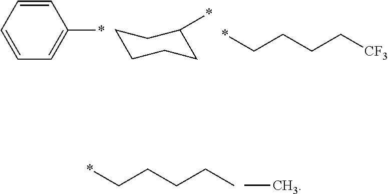

In the present disclosure, R₂ is an active organic group in POSS used for crosslinking; for R₃, R₄, R₅, and R₆: in some embodiments, the alkyl is preferably C₁-C₆ alkyl; in some embodiments, the cycloalkyl is C₃-C₆ cycloalkyl; in some embodiments, the cycloalkoxy is preferably 3- to 7-membered cycloalkoxy; in some embodiments, the alkylthio is C₁-C₆ alkylthio; in some embodiments, the alkylamino is C₁-C₆ alkylamino; in some embodiments, the alkenylamino is C₂-C₆ alkenylamino; in some embodiments, the aryl is C₆-C₁₂ aryl; in some embodiments, the aryl includes benzo C₃-C₆ cycloalkyl; in some embodiments, the heteroaryl is 5- to 12-membered heteroaryl, the 5- to 10-membered heteroaryl preferably has 1 to 3 heteroatoms selected from the group consisting of N, O, and S, and the heteroaryl preferably includes a benzo 5- to 6-membered heterocyclic group. In some embodiments, R₃, R₄, R₅, and R₆ each are methyl.

In some embodiments of the present disclosure, “substituted” includes “halogenated”, and the “halogenated” preferably includes substituted by F, Cl, Br, or I.

In some embodiments of the present disclosure, the open-cage benzocyclobutenyl polyhedral oligomeric silsesquioxane (POSS) has a structural formula shown in formula 3 or formula 4:

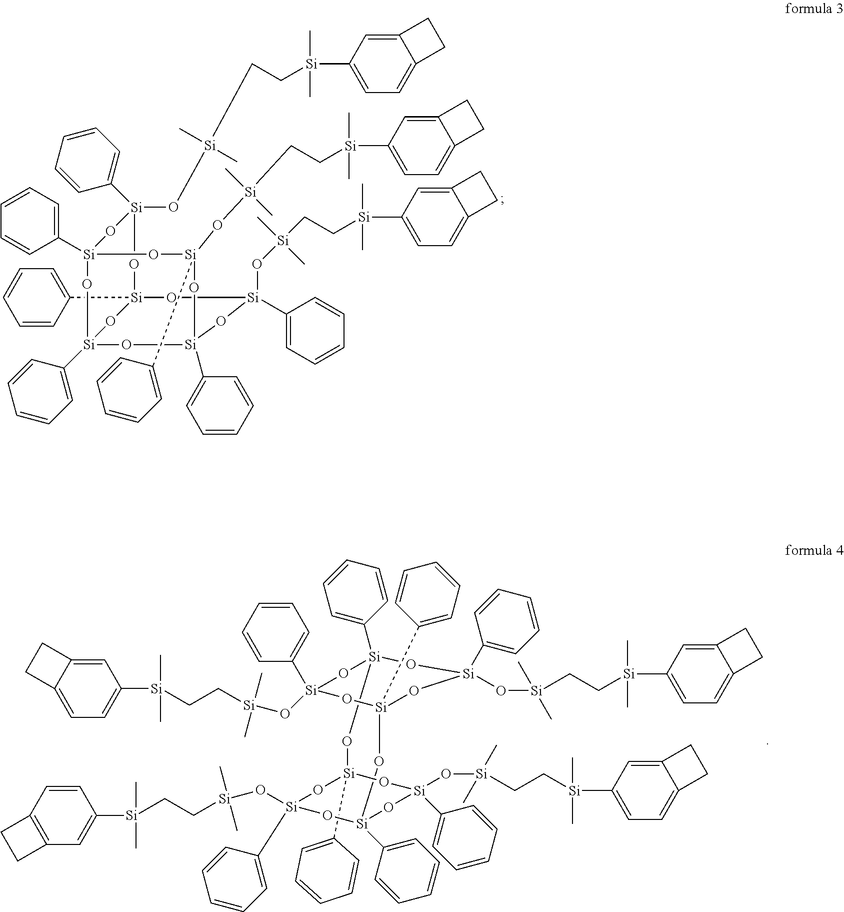

In the present disclosure, the open-cage benzocyclobutenyl polyhedral oligomeric silsesquioxane (POSS), based on its molecule-level homogeneous dispersed inorganic open-cage structure and the moderately crosslinked network formed by its low functionality, results in a cured product with good flexibility.

The present disclosure further provides a method for preparing the open-cage benzocyclobutenyl polyhedral oligomeric silsesquioxane, including the following steps:
mixing a trialkoxysilane coupling agent, an alkali metal hydroxide, water, and a first organic solvent, and conducting reaction under reflux to obtain an open-cage silanol alkali metal salt polyhedral oligomeric silsesquioxane;
mixing the open-cage silanol alkali metal salt polyhedral oligomeric silsesquioxane, vinyl chlorosilane, a first catalyst, and a second organic solvent, and conducting etherification to obtain a vinyl open-cage polyhedral oligomeric silsesquioxane; and
mixing the vinyl open-cage polyhedral oligomeric silsesquioxane, a benzocyclobutenyl silane compound, a second catalyst, and a third organic solvent, and conducting hydrosilylation to obtain the open-cage benzocyclobutenyl polyhedral oligomeric silsesquioxane (POSS); where
the trialkoxysilane coupling agent, the vinyl chlorosilane, and the benzocyclobutenyl silane compound have structural formulas shown in formula 5, formula 6, formula 6-1, and formula 7, respectively:

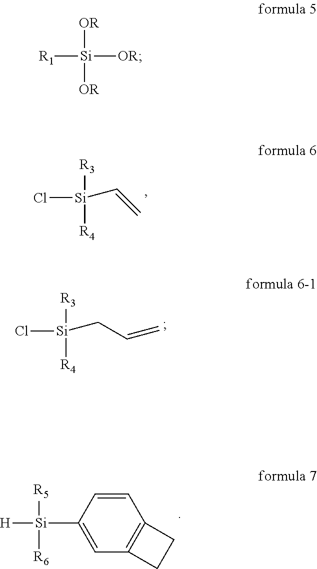

In the present disclosure, unless otherwise specified, all materials and equipment used are commercially available commodities in the art.

In the present disclosure, a trialkoxysilane coupling agent, an alkali metal hydroxide, water, and a first organic solvent are mixed, and a resulting mixture is subjected to reaction under reflux, thereby obtaining an open-cage silanol alkali metal salt polyhedral oligomeric silsesquioxane.

In some embodiments of the present disclosure, alkoxy (OR) in the trialkoxysilane coupling agent (R₁Si(OR)₃) is selected from the group consisting of methoxy and ethoxy.

In some embodiments of the present disclosure, the alkali metal hydroxide (MOH) includes KOH, NaOH, or LiOH. In some embodiments, a molar ratio of the alkali metal hydroxide to the trialkoxysilane coupling agent is in a range of 1:1.5 to 1:3, specifically being 1:2.3 or 1:1.5, for the molar ratio of 1:2.3, a hepta-R₁ trisilanol alkali metal salt polyhedral oligomeric silsesquioxane (OP₁M₃-POSS) with an OP₁ open-cage configuration is obtained; for the molar ratio of 1:1.5, an octa-R₁ tetrasilanol alkali metal salt polyhedral oligomeric silsesquioxane (OP₂M₄-POSS) with an OP₂ open-cage configuration is obtained. The reaction formula is as follows:

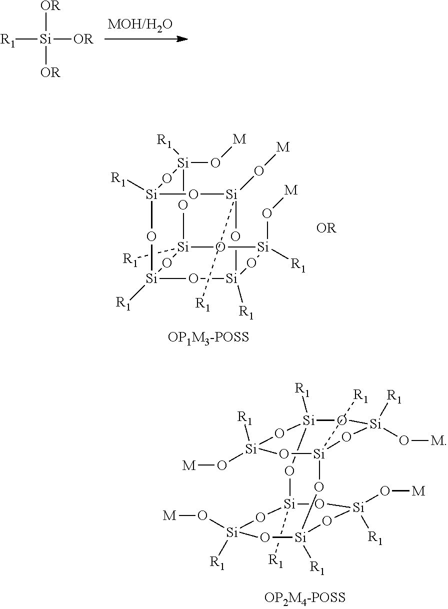

In some embodiments of the present disclosure, the amount of water used is 1 to 2 times the amount in moles of the trialkoxysilane coupling agent, and preferably 1.1 to 1.3 times.

In some embodiments of the present disclosure, the first organic solvent is a low-boiling-point organic solvent, and the low-boiling-point organic solvent preferably includes acetone, tetrahydrofuran (THF), or isopropanol.

In some embodiments of the present disclosure, a concentration of the trialkoxysilane coupling agent in the first organic solvent is in a range of 0.5 mol/L to 1.5 mol/L, and preferably 0.9 mol/L to 1.1 mol/L.

In some embodiments of the present disclosure, the reflux is performed at a temperature which enables slight boiling of the solvent; in some embodiments, the reflux is performed for 4 h to 6 h, preferably 5 h. In some embodiments, the method further includes after the reaction under reflux, cooling a resulting reaction mixture to room temperature, conducting reaction for another 15 h to 24 h, conducting solid-liquid separation, and washing and drying a resulting solid. In some embodiments, a means for the solid-liquid separation is filtration; in some embodiments, a reagent for the washing is THF; in some embodiments, the washings is performed 3 times; in some embodiments, the drying is vacuum drying; in some embodiments, vacuum drying is performed at 60° C.; in some embodiments, vacuum drying is performed for 24 h.

In the present disclosure, after obtaining the open-cage silanol alkali metal salt polyhedral oligomeric silsesquioxane, the open-cage silanol alkali metal salt polyhedral oligomeric silsesquioxane, vinyl chlorosilane, a first catalyst, and a second organic solvent are mixed, and a resulting mixture was subjected to etherification, thereby obtaining a vinyl open-cage polyhedral oligomeric silsesquioxane.

In some embodiments of the present disclosure, the vinyl chlorosilane has a chemical formula of R₃R₄ClSiCH═CH₂ or R₃R₄ClSiCH₂CH═CH₂, where R₃ and R₄ each are independently selected from the group consisting of H, alkyl, cycloalkyl, cycloalkoxy, alkylthio, alkylamino, alkenylamino, aryl, heteroaryl, substituted alkyl, substituted cycloalkyl, substituted cycloalkoxy, substituted alkylthio, substituted alkylamino, substituted alkenylamino, substituted aryl, and substituted heteroaryl. In some embodiments, the alkyl is C₁-C₆ alkyl; in some embodiments, the cycloalkyl is C₃-C₆ cycloalkyl; in some embodiments, the cycloalkoxy is 3- to 7-membered cycloalkoxy; in some embodiments, the alkylthio is C₁-C₆ alkylthio; in some embodiments, the alkylamino is C₁-C₆ alkylamino; in some embodiments, the alkenylamino is C₂-C₆ alkenylamino; in some embodiments, the aryl is C₆-C₁₂ aryl; in some embodiments, the aryl includes benzo C₃-C₆ cycloalkyl; in some embodiments, the heteroaryl is 5- to 12-membered heteroaryl, the 5- to 12-membered heteroaryl has preferably 1 to 3 heteroatoms selected from the group consisting of N, O, and S, and the heteroaryl includes preferably a benzo 5- to 6-membered heterocyclic group. In some embodiments, R₃ and R₄ each are methyl.

In some embodiments of the present disclosure, “substituted” includes “halogenated”, and the “halogenated” preferably includes substituted by F, Cl, Br, or I.

In some embodiments of the present disclosure, a molar ratio of an alkali metal element in the open-cage silanol alkali metal salt polyhedral oligomeric silsesquioxane (OP₁M₃-POSS/OP₂M₄-POSS) to the vinyl chlorosilane is in a range of 1:2 to 1:4, preferably 1:3.

In some embodiments of the present disclosure, the first catalyst includes an organic base, and the organic base preferably includes triethylamine (TEA), pyridine, or diethylamine, and is more preferably TEA.

In some embodiments of the present disclosure, the molar amount of the of the organic base is equal to a difference between the molar amount of the vinyl chlorosilane and the molar amount of the vinyl in the vinyl open-cage polyhedral oligomeric silsesquioxane.

In some embodiments of the present disclosure, the second organic solvent is an aprotic low-boiling-point solvent, and the aprotic low-boiling-point solvent preferably includes one or more selected from the group consisting of dichloromethane (DCM), THF, and toluene.

In some embodiments of the present disclosure, a concentration of the open-cage silanol alkali metal salt polyhedral oligomeric silsesquioxane in the second organic solvent is in a range of 0.05 mol/L to 0.15 mol/L, and specifically may be 0.067 mol/L, 0.08 mol/L, or 0.1 mol/L.

In some embodiments of the present disclosure, the etherification is conducted under the protection of an inert gas, and the inert gas is preferably nitrogen. In some embodiments, the etherification is conducted at a temperature of 0° C. to 25° C. (specifically 20° C.) for 24 h to 36 h (specifically 24 h). The obtained vinyl open-cage polyhedral oligomeric silsesquioxane has a structural formula shown in formula 8 or formula 9:

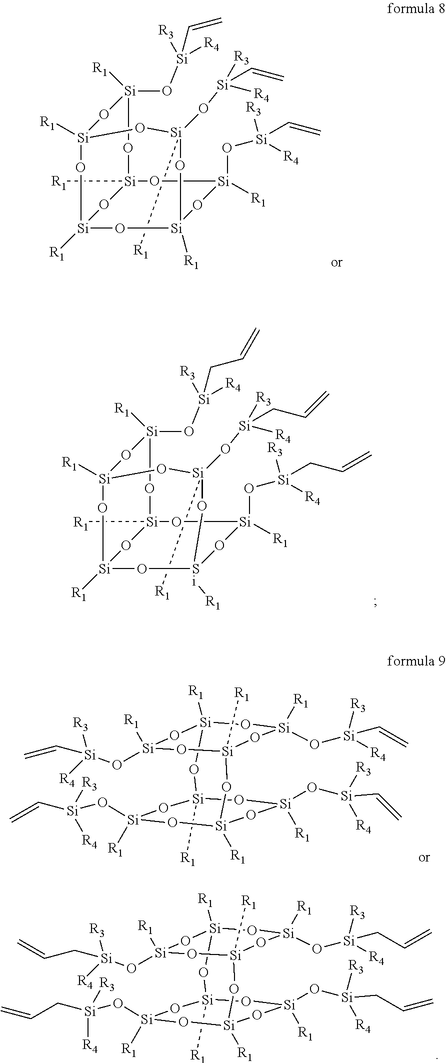

In some embodiments of the present disclosure, after the etherification is completed, the method further includes: filtering to remove insoluble solids, subjecting a resulting filtrate to rotary evaporation to remove the solvent, and washing and drying an obtained solid; in some embodiments, a reagent for the washing is methanol; in some embodiments, the washings is performed 3 times; in some embodiments, the drying is performed by vacuum drying; in some embodiments, the vacuum drying is conducted at 40° C., preferably for 24 h.

In the present disclosure, after obtaining the vinyl open-cage polyhedral oligomeric silsesquioxane, the vinyl open-cage polyhedral oligomeric silsesquioxane, a benzocyclobutenyl silane compound, a second catalyst, and a third organic solvent are mixed, and a resulting mixture is subjected to hydrosilylation, thereby obtaining the open-cage benzocyclobutenyl polyhedral oligomeric silsesquioxane (POSS).

In some embodiments of the present disclosure, a molar ratio of vinyl in the vinyl open-cage polyhedral oligomeric silsesquioxane to the benzocyclobutenyl silane compound is in a range of 1:1 to 1:1.5, specifically 1:1.2.

In some embodiments of the present disclosure, a molarity of the vinyl open-cage polyhedral oligomeric silsesquioxane (OP₁V₃—POSS/OP₂V₄—POSS) in the third organic solvent is in a range of 0.05 mol/L to 0.5 mol/L, and preferably 0.06 mol/L to 0.3 mol/L.

In some embodiments of the present disclosure, the second catalyst includes one or more selected from the group consisting of chloroplatinic acid, chloroplatinic acid-isopropanol solution, methylvinylsiloxane-platinum complex, and Karstedt catalyst.

In some embodiments of the present disclosure, a ratio of a mass of the second catalyst to an amount in moles of the benzocyclobutenyl silane compound is in a range of 0.025 g/mol to 0.25 g/mol, and preferably 0.05 g/mol to 0.2 g/mol.

In some embodiments of the present disclosure, the third organic solvent is an inert solvent, and the inert solvent preferably includes a C₁-C₁₀ alkane solvent and/or a C₆-C₁₂ aromatic hydrocarbon solvent, more preferably includes one or more of DCM, chloroform, dichloroethane, trichloroethane, n-hexane, cyclohexane, chlorobenzene, toluene, xylene, and trimethylbenzene, and may specifically be toluene.

In some embodiments of the present disclosure, the hydrosilylation is conducted under the protection of an inert gas, and the inert gas is preferably nitrogen. In some embodiments, the hydrosilylation is conducted at a temperature of 90° C. to 110° C. (specifically 100° C.); in some embodiments, the hydrosilylation is conducted for 24 h to 48 h (preferably 30 h to 36 h). The obtained open-cage benzocyclobutenyl polyhedral oligomeric silsesquioxane is represented by formula 10 and formula 11:

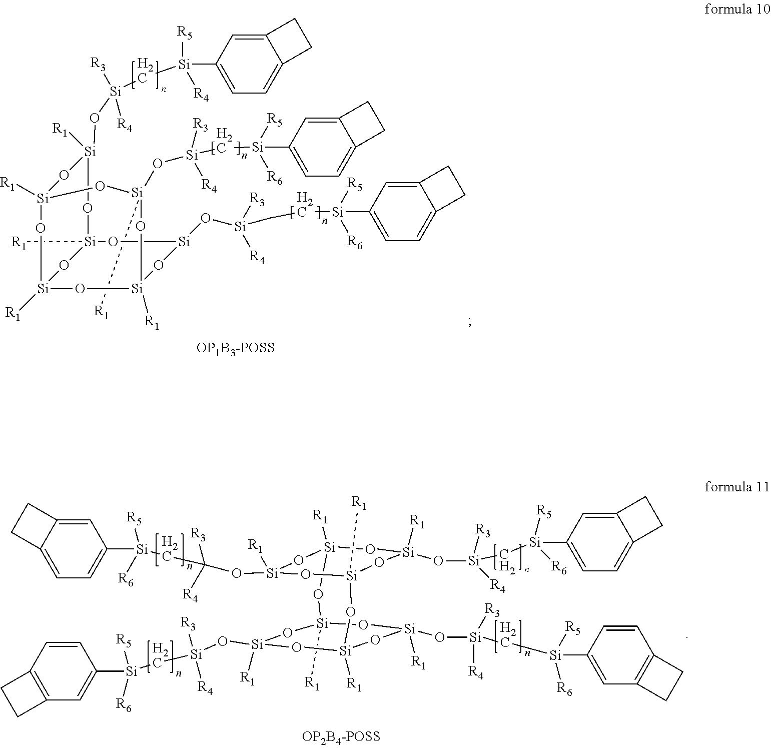

In the structures of the open-cage benzocyclobutenyl polyhedral oligomeric silsesquioxane of formula 10 or formula 11, n is 2 or 3 depending on the structure of the aforementioned vinyl open-cage polyhedral oligomeric silsesquioxane.

The present disclosure further provides use of the open-cage benzocyclobutenyl polyhedral oligomeric silsesquioxane as described in above technical solutions or the open-cage benzocyclobutenyl polyhedral oligomeric silsesquioxane prepared by the method as described above in the field of wireless communications.

The present disclosure further provides a cured material, where the cured material is obtained by crosslinking and curing the open-cage benzocyclobutenyl polyhedral oligomeric silsesquioxane as described in above technical solutions or the open-cage benzocyclobutenyl polyhedral oligomeric silsesquioxane prepared by the method as described above.

In some embodiments of the present disclosure, the cured material includes a resin bulk material or a resin film. In some embodiments, the resin bulk material is prepared by a process including the following steps:
melting the open-cage benzocyclobutenyl polyhedral oligomeric silsesquioxane to obtain a homogeneous viscous liquid; and
subjecting the homogeneous viscous liquid to a first crosslinking and curing, thereby obtaining the resin bulk material.

In some embodiments of the present disclosure, the melting is conducted under a protective gas atmosphere; in some embodiments, the melting is conducted at a temperature of 80° C. to 90° C. for preferably 2 h to 4 h; in some embodiments, the melting is conducted under a pressure of −0.08 MPa.

In some embodiments of the present disclosure, the first crosslinking and curing is conducted under a protective gas atmosphere; in some embodiments, the first crosslinking and curing is a stepwise curing process; in some embodiments, the stepwise curing process includes: a first stage curing, a second stage curing, and a third stage curing. In some embodiments, the first stage curing is conducted at 90° C. for preferably 2 h; in some embodiments, the second stage curing is conducted at 210° C. for preferably 2 h; in some embodiments, the third stage curing is conducted at 230° C. for preferably 2 h. In some embodiments, heating rates from the melting temperature to a first stage curing temperature, from the first stage curing temperature to a second stage curing temperature, and from the second stage curing temperature to a third stage curing temperature are all 10° C./min. During the crosslinking and curing, the POSS self-crosslinks to form a three-dimensionally crosslinked thermosetting resin bulk material.

In some embodiments, a resin film is prepared by a process including the following steps:
dissolving the open-cage benzocyclobutenyl polyhedral oligomeric silsesquioxane in an organic solvent, spin-coating or drop-coating an obtained solution onto a metal substrate, leaving to evaporate the organic solvent, then conducting a second crosslinking and curing, and etching away the metal substrate by placing a coated metal substrate in an aqueous solution of a strong acid, thereby obtaining the resin film.

In some embodiments of the present disclosure, the organic solvent includes one or more of toluene, xylene, trimethylbenzene, diphenyl ether, cyclohexanone, DCM, chloroform, acetone, N,N-dimethylformamide (DMF), N,N-dimethylacetamide (DMA), dimethyl sulfoxide (DMSO), and N-methylpyrrolidone (NMP).

In some embodiments of the present disclosure, the metal substrate is a metal substrate that is easily corroded by an acid, and the metal substrate that is easily corroded by the acid preferably includes an aluminum plate, a copper plate, an iron plate, or a zinc plate.

In some embodiments of the present disclosure, the organic solvent is evaporated at a temperature of 100° C. to 150° C. for preferably 8 h to 12 h.

In some embodiments of the present disclosure, the second crosslinking and curing is conducted in the same manner as the first crosslinking and curing, which will not be repeated here.

In some embodiments of the present disclosure, the aqueous solution of the strong acid has a concentration of 5 wt % to 15 wt %, and preferably 10 wt %.

In the present disclosure, the thermosetting resin is an organic-inorganic hybrid thermosetting material that combines an ultra-low dielectric constant, ultra-low dielectric loss, high heat resistance, and flexibility.

In order to further illustrate the present disclosure, the open-cage benzocyclobutenyl polyhedral oligomeric silsesquioxane thermosetting resin, and a preparation method and use thereof provided by the present disclosure are described in detail below in conjunction with the accompanying drawings and examples, but the accompanying drawings and the examples should not be construed as limiting the scope of the present disclosure.

### Example 1: benzocyclobutenyl-silane (BCB—SiH)

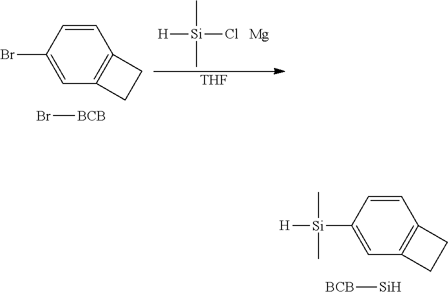

Under a nitrogen atmosphere, 120.0 mmol of magnesium turnings, 150 mL of anhydrous THF, and 150.0 mmol of dimethylchlorosilane were added to a dried 250 mL three-necked flask. 100.0 mmol of 4-bromobenzocyclobutene (Br—BCB) was then added dropwise slowly at a rate of 1 drop/second. After the addition was completed, a resulting mixture was reacted overnight at room temperature. After the reaction was completed, THF therein was removed by rotary evaporation, and 200 mL of n-hexane was added. An insoluble inorganic salt was removed by filtration, and a resulting filtrate was concentrated to remove solvent therein, and then distilled under reduced pressure, obtaining 13.2 g of a colorless transparent liquid compound, benzocyclobutenyl-silane (BCB—SiH), with a yield of 81.5%.

The structural characterizations were as follows:

¹H-NMR (400 MHz, Chloroform-d)), δ(ppm): 7.48 (1H), 7.33 (1H), 7.15 (1H), 4.50 (1H), 3.27 (4H), 0.41 (6H).

¹³C-NMR (100 MHz, Chloroform-d), δ (ppm): 147.45, 145.58, 135.57, 132.43, 127.86, 122.17, 30.04, −3.31.

²⁹Si-NMR (119 MHz, CDCl₃), δ (ppm): −16.39.

### Example 2: p-Tolylhydrosilane (T-SiH)

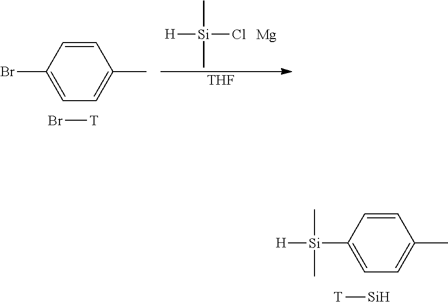

Under a nitrogen atmosphere, 120.0 mmol of magnesium turnings, 150 mL of anhydrous THF, and 150.0 mmol of dimethylchlorosilane were added to a dried 250 mL three-necked flask. 100.0 mmol of p-bromotoluene (Br-T) was then added dropwise slowly at a rate of 1 drop/second. After the addition was completed, a resulting mixture was reacted overnight at room temperature. After the reaction was completed, THF therein was removed by rotary evaporation, and 200 mL of n-hexane was added thereto. The insoluble inorganic salts were removed by filtration, a resulting filtrate was concentrated to remove the solvent therein, and then distilled under reduced pressure, obtaining 12.7 g of a colorless transparent liquid compound, p-tolylhydrosilane (T-SiH), with a yield of 78.3%.

The structural characterizations were as follows:

¹H-NMR (400 MHz, CDCl₃), δ (ppm): 7.56 (2H), 7.31 (2H), 4.55 (1H), 2.47 (3H), 0.45 (6H);

¹³C-NMR (100 MHz, CDCl₃), δ (ppm): 134.15, 128.78, 29.6, 21.58, −3.64;

²⁹Si-NMR (119 MHz, CDCl₃), δ (ppm): −16.39.

### Example 3: Open-Cage Heptaphenyl Tris(BCB) Polyhedral Oligomeric Silsesquioxane (OP₁B₃—POSS)

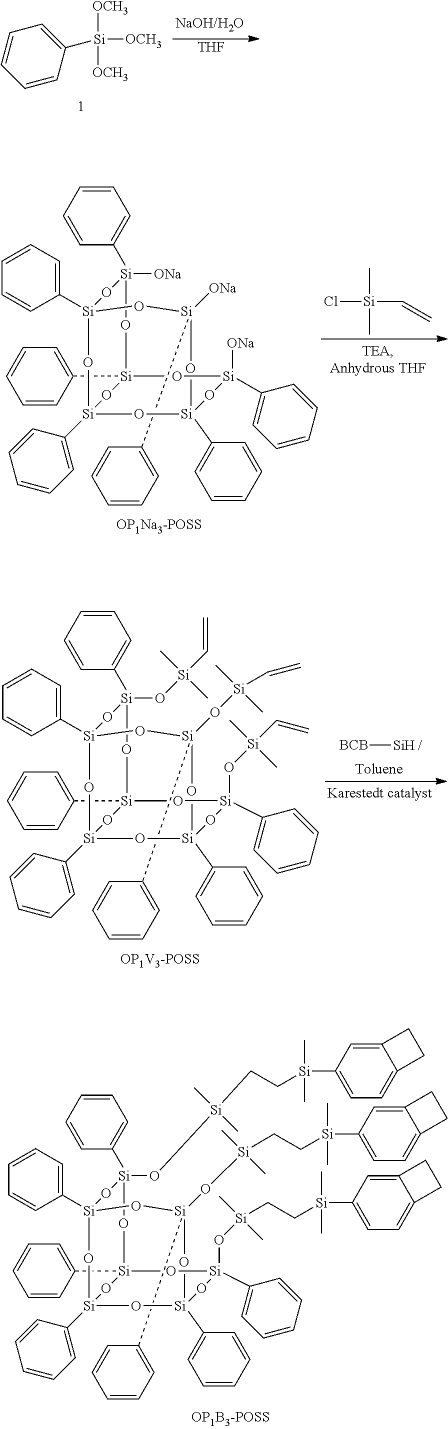

230.0 mmol of phenyltrimethoxysilane, 250 mL of anhydrous THF, 98.6 mmol of sodium hydroxide (NaOH), and 290 mmol of deionized water were added to a 500 mL three-necked flask sequentially. A resulting mixture was reacted under reflux for 5 h, then cooled to room temperature and reacted for another 15 h. After the reaction was completed, a resulting reaction mixture was filtered; and a resulting filter cake was washed three times with THF, and vacuum-dried at 60° C. for 24 h, obtaining 25.3 g of a white solid, namely open-cage heptaphenyl trisilanol sodium salt polyhedral oligomeric silsesquioxane (OP₁Na₃—POSS), was obtained, with a yield of 78.6%.

Under a nitrogen atmosphere, 90 mmol of vinyldimethylchlorosilane, 100 mL of anhydrous THF, and 60 mmol of TEA were sequentially added to a dried 250 mL three-necked flask. 10 mmol of the open-cage heptaphenyl trisilanol sodium salt polyhedral oligomeric silsesquioxane (OP₁Na₃—POSS) was then added thereto in five batches. A resulting mixture was reacted at a constant temperature of 20° C. for 24 h. After the reaction was completed, insoluble solids were removed by filtration, and a resulting filtrate was subjected to rotary evaporation to remove the solvent therein to obtain a white solid. This white solid was washed three times with methanol and vacuum dried at 40° C. for 24 h, obtaining 5.6 g of open-cage heptaphenyl trivinyl polyhedral oligomeric silsesquioxane (OP₁V₃—POSS), with a yield of 56.1%.

Under a nitrogen atmosphere, 3 mmol of the open-cage heptaphenyl trivinyl polyhedral oligomeric silsesquioxane (OP₁V₃—POSS), 50 mL of toluene, and 10.8 mmol of BCB—SiH were sequentially added to a dried 100 mL three-necked flask. 5 drops of Karstedt catalyst were added dropwise thereto to initiate reaction, and the reaction was conducted at 100° C. for 30 h. After the reaction was completed, a resulting reaction mixture was removed by concentration under reduced pressure to remove the bulk of the toluene, and a residue was purified by silica gel chromatography, obtaining 4.0 g of a white solid, namely the open-cage heptaphenyl tris(BCB) polyhedral oligomeric silsesquioxane (OP₁B₃—POSS).

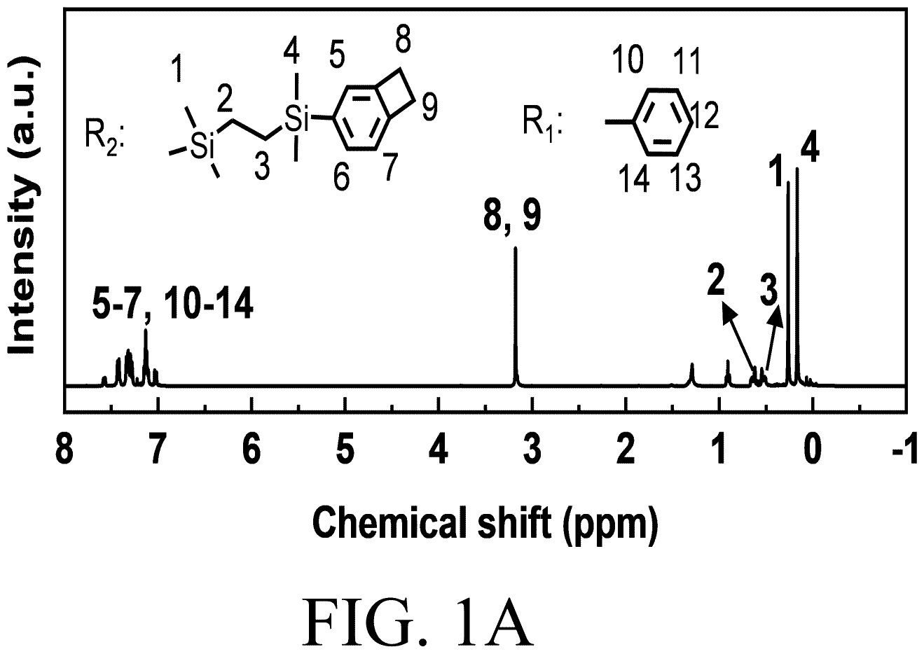

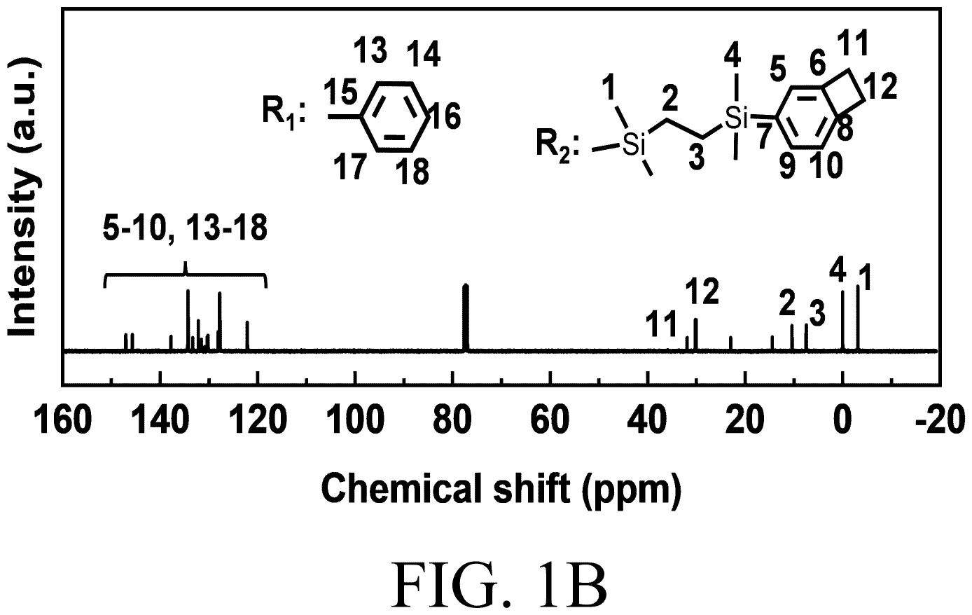

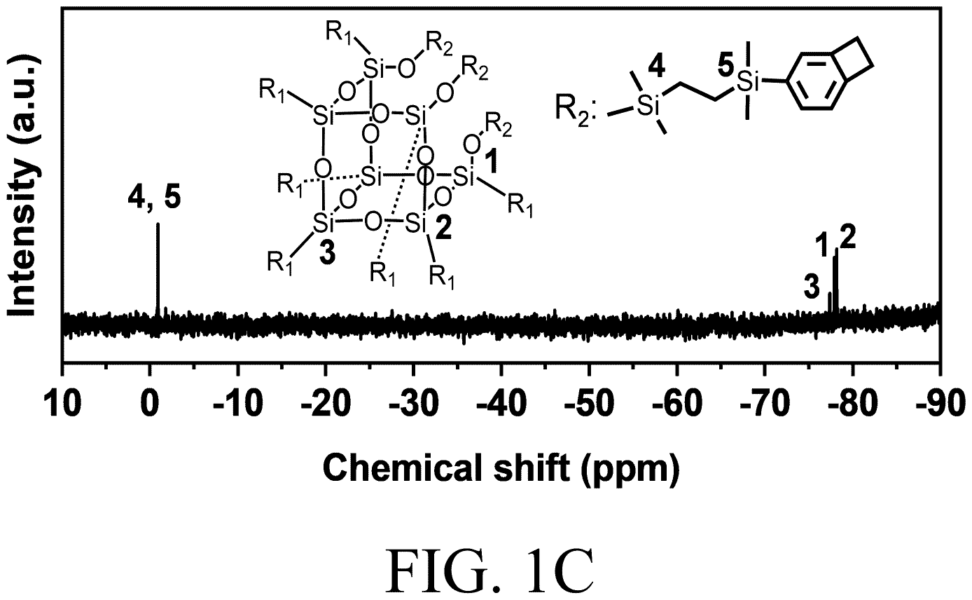

FIG. 1A to FIG. 1C show the ¹H (FIG. 1A), ¹³C (FIG. 1B), ²⁹Si (FIG. 1C) NMR spectral data of OP₁B₃—POSS. Its structural characterizations were as follows:

¹H-NMR (400 MHz, Chloroform-d)), δ (ppm): 7.65-7.00 (44H), 3.20 (12H), 0.70-0.48 (12H), 0.29 (18H), 0.19 (18H)

¹³C-NMR (150 MHz, Chloroform-d), δ (ppm): 147.17, 145.85, 138.13, 132.35, 127.85, 122.26, 135.00-127.00 (40C), 30.43, 30.28, 10.64, 7.63, −0.00, −3.14

²⁹Si-NMR (119 MHz, Chloroform-d), δ (ppm): 11.65, −1.22, −76.13, −78.65.

### Example 4: Open-Cage Octaphenyl Tetrakis(BCB) Polyhedral Oligomeric Silsesquioxane (OP₂B₄—POSS)

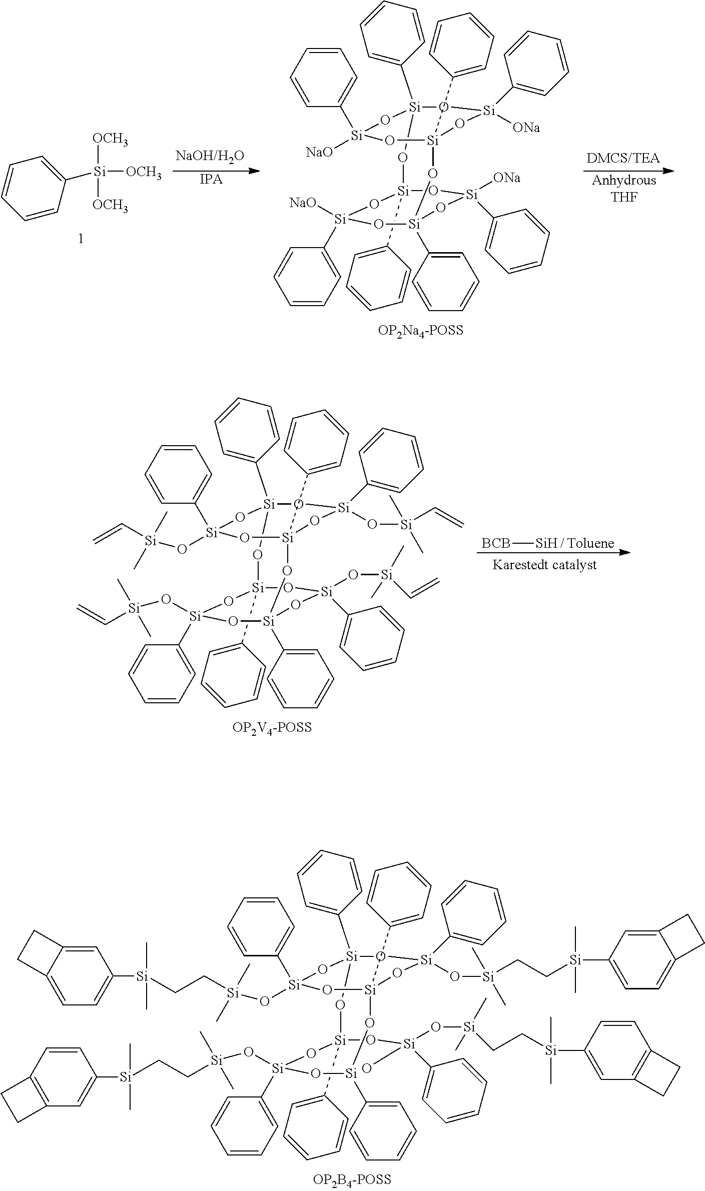

160.0 mmol of phenyltrimethoxysilane, 160 mL of isopropanol (IPA), 106.7 mmol of sodium hydroxide (NaOH), and 185.0 mmol of deionized water were added to a 500 mL three-necked flask sequentially. A resulting mixture was reacted under reflux for 5 h, then cooled to room temperature and reacted for another 15 h. After the reaction was completed, a resulting reaction mixture was filtered; and a resulting filter cake was washed three times with THF and vacuum-dried at 60° C. for 24 h, obtaining 24.3 g of a white solid, namely open-cage octaphenyl tetrasilanol sodium salt polyhedral oligomeric silsesquioxane (OP₂Na₄—POSS), with a yield of 87.0%.

Under a nitrogen atmosphere, 120 mmol of vinyldimethylchlorosilane, 150 mL of anhydrous THF, and 80 mmol of TEA were sequentially added to a dried 250 mL three-necked flask. 10 mmol of the open-cage octaphenyl tetrasilanol sodium salt polyhedral oligomeric silsesquioxane (OP₂Na₄—POSS) was added in five batches. A resulting mixture was reacted at a constant temperature of 20° C. for 24 h. After the reaction was completed, insoluble solids therein were removed by filtration, and a resulting filtrate was subjected to rotary evaporation to remove solvent therein to obtain a white solid. This white solid was washed three times with methanol and vacuum-dried at 40° C. for 24 h, obtaining 7.6 g of open-cage octaphenyl tetravinyl polyhedral oligomeric silsesquioxane (OP₂V₄—POSS), with a yield of 54.3%.

Under a nitrogen atmosphere, 3 mmol of the open-cage octaphenyl tetravinyl polyhedral oligomeric silsesquioxane (OP₂V₄—POSS), 50 mL of toluene, and 14.4 mmol of BCB—SiH were sequentially added to a dried 100 mL three-necked flask. 5 drops of Karstedt catalyst were added dropwise to initiate reaction, and the reaction was conducted at 100° C. for 30 h. After the reaction was completed, a resulting reaction mixture was concentrated under reduced pressure to remove the bulk of toluene, and a residue was purified by silica gel chromatography, obtaining 5.4 g of a white solid, namely the open-cage octaphenyl tetrakis(BCB) polyhedral oligomeric silsesquioxane (OP₂B₄—POSS), with a yield of 88.0%.

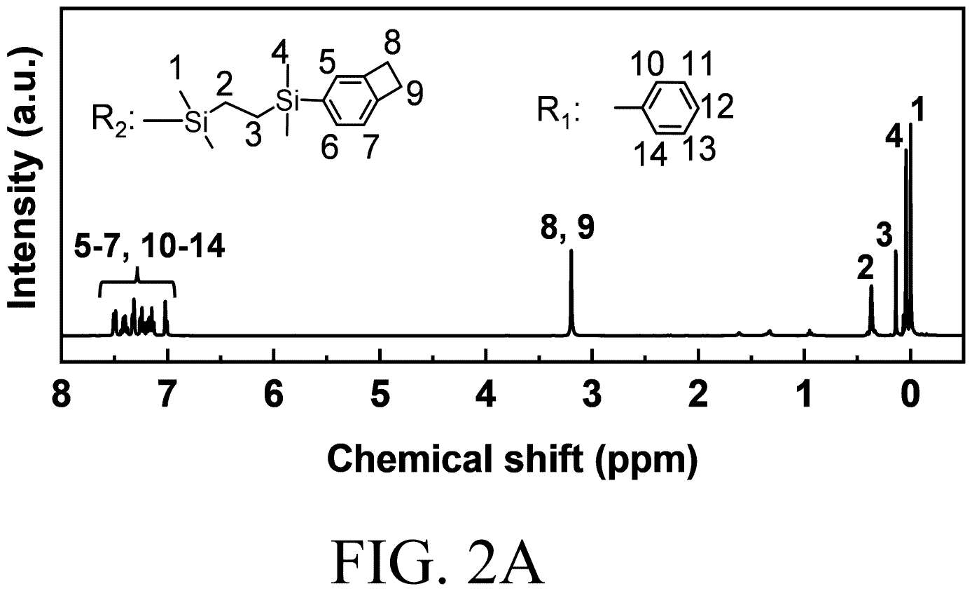

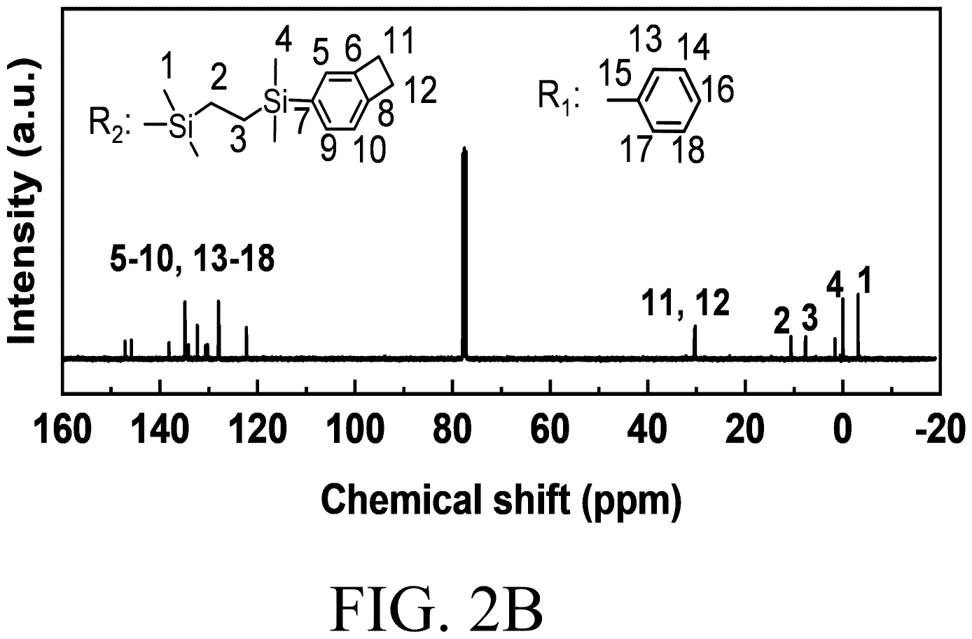

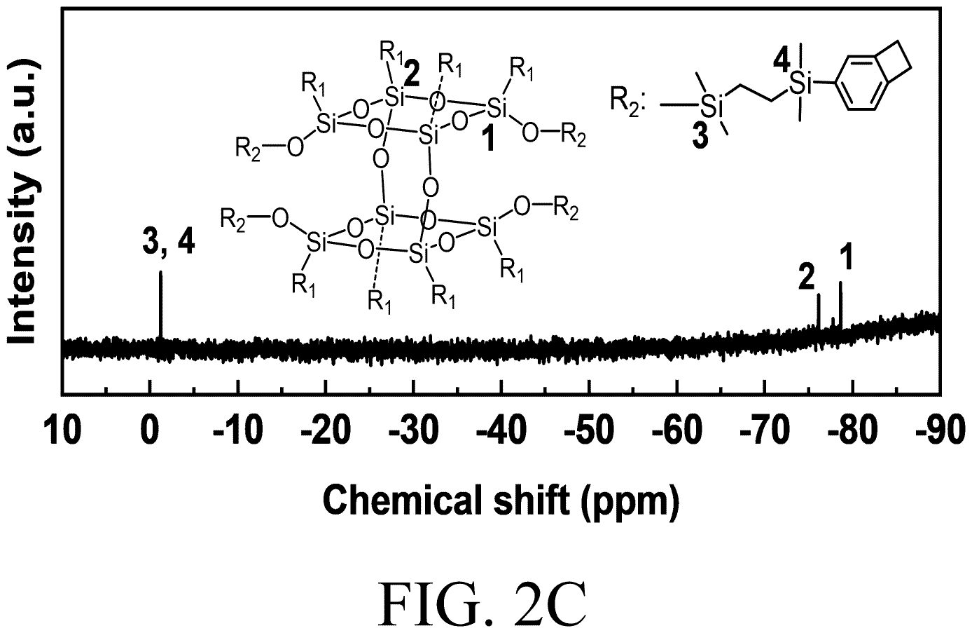

FIG. 2A to FIG. 2C show the ¹H (FIG. 2A), ¹³C (FIG. 2B), ²⁹Si (FIG. 2C) NMR spectral data of OP₂B₄—POSS. Its structural characterizations were as follows:

¹H-NMR (400 MHz, Chloroform-d), δ (ppm): 7.55-6.95 (52H), 3.20 (4H), 0.37 (t, 8H), 0.14 (8H), 0.04 (s, 24H), 0.00 (s, 24H).

¹³C-NMR (150 MHz, Chloroform-d), δ (ppm): 147.17, 145.85, 138.13, 132.35, 127.85, 122.26, 135.00-127.00 (40C), 30.43, 30.28, 10.64, 7.63, −0.00, −3.14;

²⁹Si-NMR (119 MHz, Chloroform-d), δ (ppm): 11.65, −1.22, −76.13, −78.65.

### Comparative Example 1: Closed-Cage Octa(BCB) Polyhedral Oligomeric Silsesquioxane (OP₀B₈—POSS)

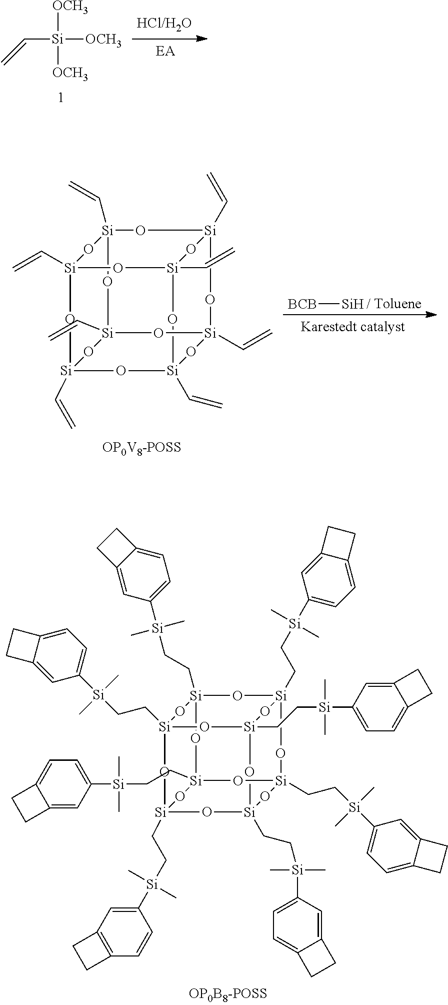

200 mL of ethyl acetate (EA) and 30 mL of vinyltrimethoxysilane (VTMS) were added to a dried 250 mL three-necked flask, and a resulting mixture was stirred at 20° C. for 30 min. 42 mL of concentrated hydrochloric acid (HCl) and 18 mL of deionized water were then added to a 100 mL constant-pressure funnel and a mixture therein was then added dropwise into the flask under continuous stirring. The addition was completed within 30 min, and a resulting mixture was reacted at a constant temperature of 40° C. for 96 h. Subsequently, a resulting reaction mixture was filtered to remove the solvent therein, obtaining 14.08 g of a white powder, namely closed-cage octavinyl OP₀V₈—POSS, with a yield of 87.6%.

Under a nitrogen atmosphere, 100 mL of toluene, 10 mmol of the OP₀V₈—POSS, and 96 mmol of BCB—SiH were added to a dried 250 mL three-necked flask. A resulting mixture was stirred for 30 min, and 5 drops of Karstedt catalyst were added dropwise thereto. A resulting mixture was reacted at 100° C. for 30 h. After the reaction, a resulting reaction mixture was concentrated under reduced pressure and purified by column chromatography, obtaining 17.4 g of a white powder, namely the OP₀B₈—POSS, with a yield of 90.0%.

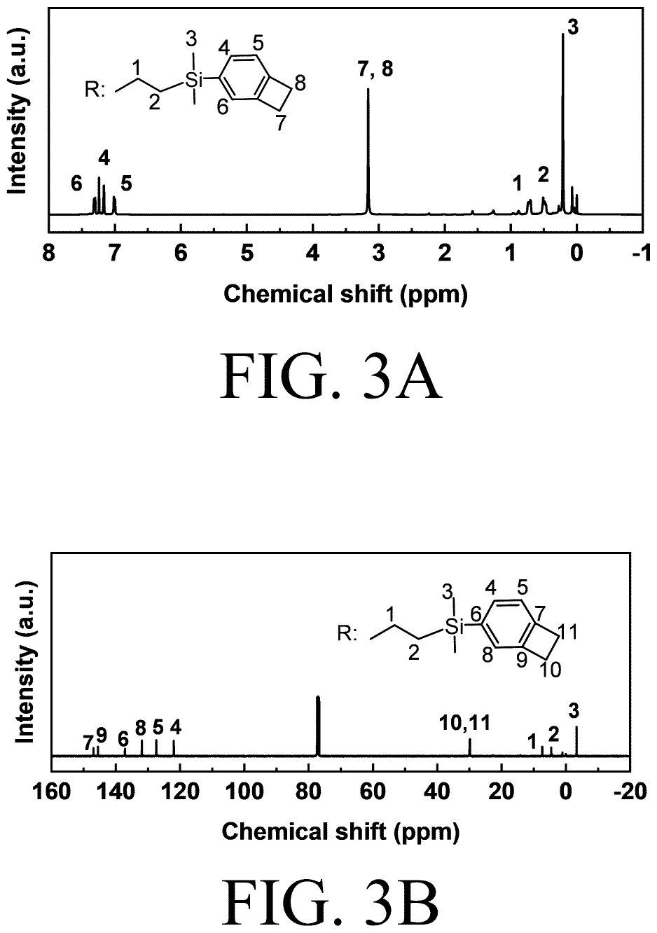

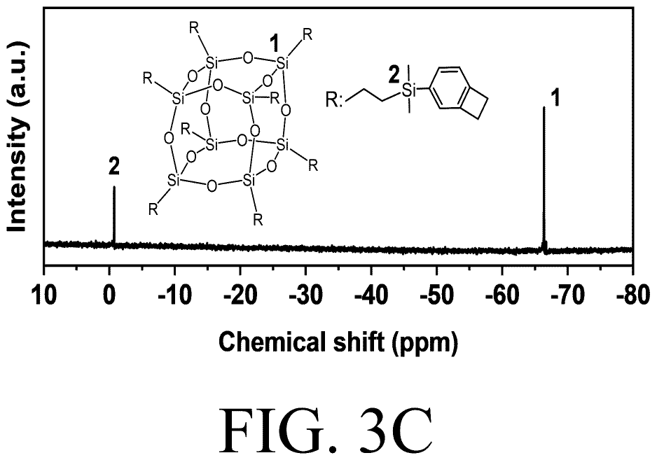

FIG. 3A to FIG. 3C show the ¹H (FIG. 3A), ¹³C (FIG. 3B), ²⁹Si (FIG. 3C) NMR spectral data of OP₀B₈—POSS. Its structural characterizations were as follows:

¹H-NMR (400 MHz, Chloroform-d)), δ (ppm): 7.31 (d, J=7.2 Hz, 1H), 7.17 (s, 8H), 7.17 (d, J=6.8 Hz, 8H), 3.16 (s, 32H), 0.21 (s, 48H).

¹³C-NMR (150 MHz, Chloroform-d), δ (ppm): 147.44, 145.58, 135.58, 132.42, 127.85, 122.16, 29.98, 29.80, 7.35, 4.57, −3.32;

²⁹Si-NMR (119 MHz, Chloroform-d), δ (ppm): −0.76, −66.39.

### Comparative Example 2: Closed-Cage Tetrakis(BCB) Tetrakis(p-Tolyl) Polyhedral Oligomeric Silsesquioxane (OP₀B₄T₄-POSS)

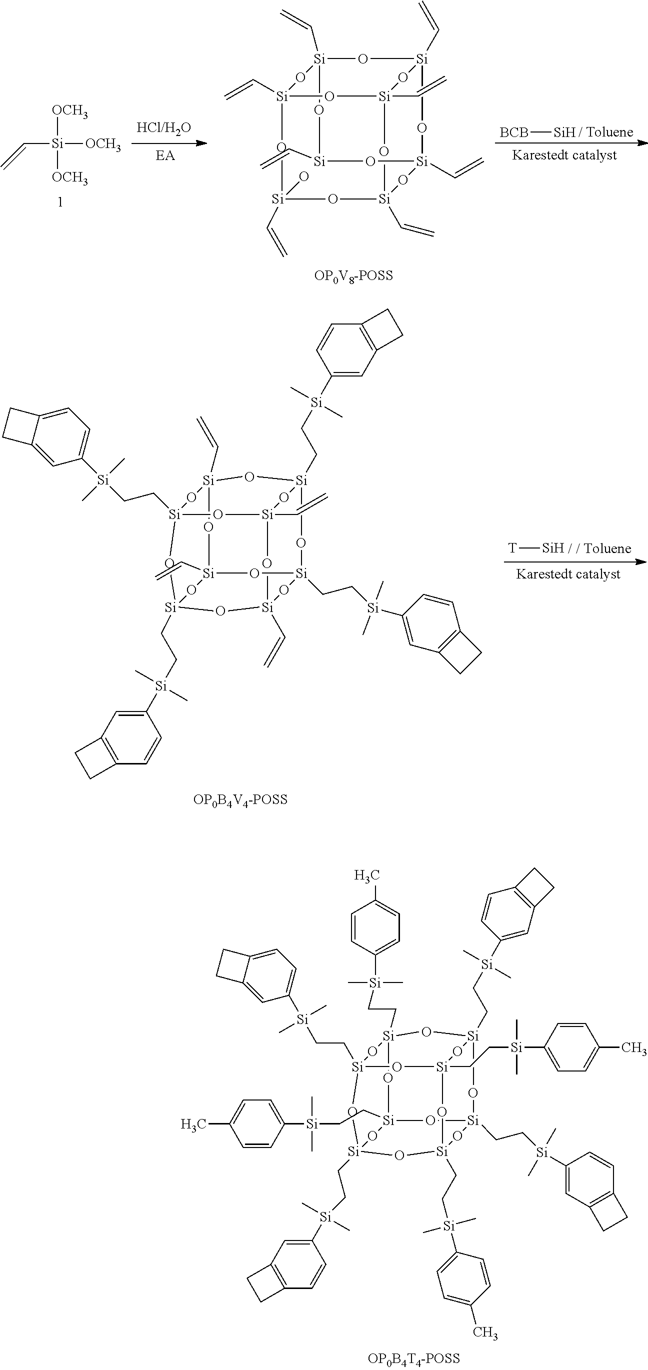

The preparation of OP₀V₈—POSS was the same as that in Comparative Example 1.

Under a nitrogen atmosphere, 100 mL of toluene, 10 mmol of the OP₀V₈—POSS, and 40 mmol of BCB—SiH were added to a dried 250 mL three-necked flask. A resulting mixture was stirred for 30 min, 5 drops of Karstedt catalyst were then added dropwise, and a resulting mixture was reacted at 100° C. for 30 h. Subsequently, 60 mmol of T-SiH was added thereto, and the reaction was continued at 100° C. for another 30 h. A resulting reaction mixture was then concentrated under reduced pressure and a residue was purified by column chromatography, obtaining 16.0 g of a white powder, namely the OP₀B₄T₄-POSS, with a yield of 85.3%.

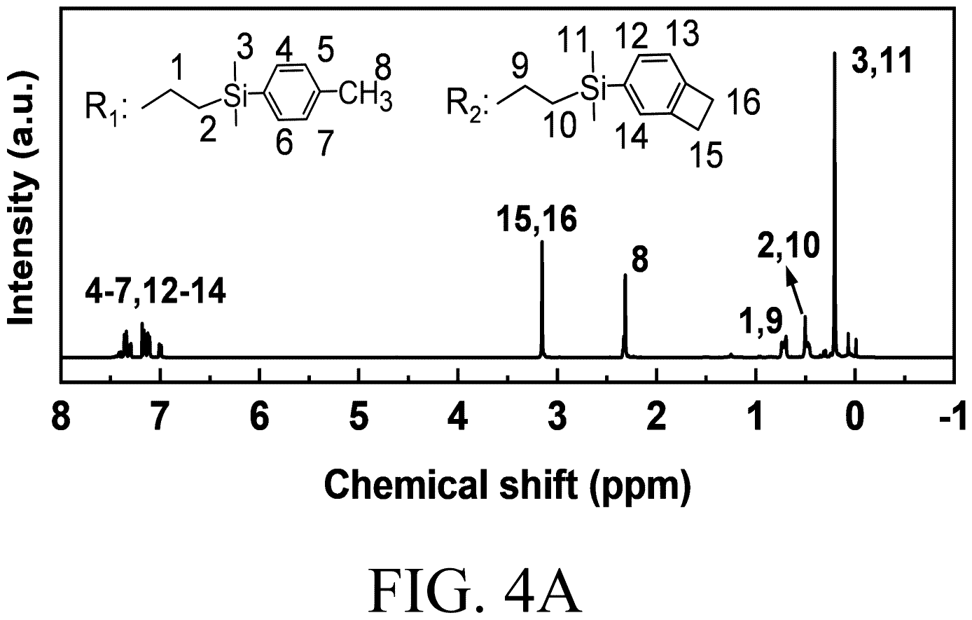

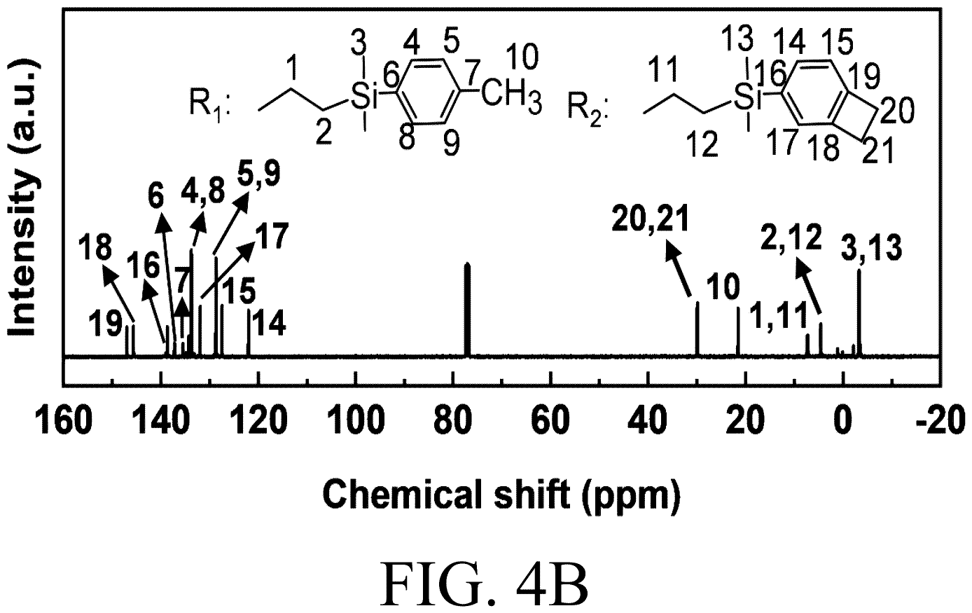

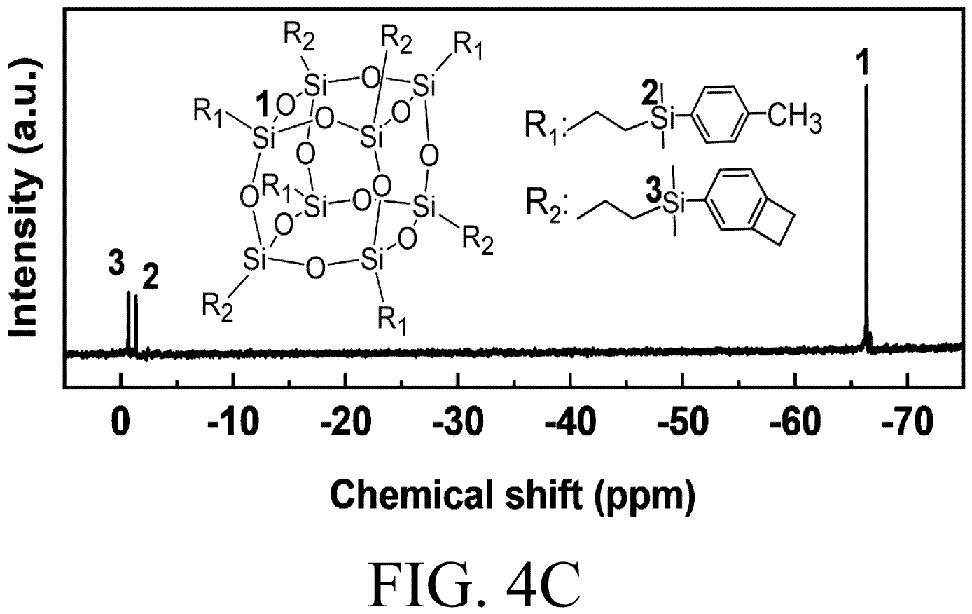

FIG. 4A to FIG. 4C show the ¹H (FIG. 4A), ¹³C (FIG. 4B), ²⁹Si (FIG. 4C) NMR spectral data of OP₀B₄T₄-POSS. Its structural characterizations were as follows:

¹H-NMR (400 MHz, Chloroform-d)), δ (ppm): 7.50-6.96 (28H), 3.16 (s, 32H), 2.32 (12H), 0.7 (16H), 0.5 (16H), 0.22 (48H).

¹³C-NMR (150 MHz, Chloroform-d), δ (ppm): 146.97, 145.60, 138.65, 133.72, 131.92, 128.69, 127.44, 122.02, 29.98, 29.80, 7.35, 4.60, −3.29, −3.42;

²⁹Si-NMR (119 MHz, Chloroform-d), δ (ppm): −0.70, −1.37, −66.35;

### Example 5: Thermosetting Resin c-OP₁B₃ Based on the OP₁B₃—POSS

The open-cage OP₁B₃—POSS obtained in Example 3 was loaded into a polytetrafluoroethylene mold and placed in a vacuum oven at a pressure of −0.08 MPa and a temperature of 90° C. for 2 h to melt it and eliminate bubbles, resulting in a homogeneous, viscous POSS melt. Subsequently, curing was conducted in 3 stages. In the first stage, the temperature was slowly raised to 190° C. at a rate of 10° C./min and held for 2 h; in the second stage, the temperature was slowly raised to 210° C. and held for 2 h; and in the third stage, the temperature was slowly raised to 230° C. and held for 2 h, thus obtaining a thermosetting resin formed by thermal crosslinking of the OP₁B₃—POSS, denoted as c-OP₁B₃.

### Example 6: Thermosetting Resin c-OP₂B₄ Based on the Double-Open-Cage OP₂B₄—POSS

The open-cage OP₂B₄—POSS obtained in Example 4 was loaded into a glass mold and placed in a vacuum oven at a pressure of −0.08 MPa and a temperature of 90° C. for 2 h to melt it and eliminate bubbles, resulting in a homogeneous, viscous POSS melt. Subsequently, curing was conducted in 3 stages. In the first stage, the temperature was slowly raised to 190° C. and held for 2 h; in the second stage, the temperature was slowly raised to 210° C. and held for 2 h; and in the third stage, the temperature was slowly raised to 230° C. and held for 2 h, thus obtaining a thermosetting resin formed by thermal crosslinking of the OP₂B₄—POSS, denoted as c-OP₂B₄.

### Comparative Example 3: Thermosetting Resin c-OP₀B₈ Based on the Closed-Cage OP₀B₈—POSS

The closed-cage OP₀B₈—POSS obtained in Comparative Example 1 was loaded into a glass mold and placed a vacuum oven at a pressure of −0.08 MPa and a temperature of 120° C. for 2 h to melt it and eliminate bubbles, resulting in a homogeneous, viscous POSS melt. Subsequently, curing was conducted in 3 stages. In the first stage, the temperature was slowly raised to 190° C. and held for 2 h; in the second stage, the temperature was slowly raised to 210° C. and held for 2 h; and in the third stage, the temperature was slowly raised to 230° C. and held for 2 h, thus obtaining a thermosetting resin formed by thermal crosslinking of the OP₀B₈—POSS, denoted as c-OP₀B₈.

### Comparative Example 4: Thermosetting Resin c-OP₀B₄T₄ Based on the Closed-Cage OP₀B₄T₄-POSS

The closed-cage OP₀B₄T₄-POSS synthesized in Comparative Example 2 was loaded into a polytetrafluoroethylene mold and placed a vacuum oven at a pressure of −0.08 MPa and a temperature of 120° C. for 2 h to melt it and eliminate bubbles, resulting in a homogeneous, viscous POSS melt. Subsequently, curing was conducted in 3 stages. In the first stage, the temperature was slowly raised to 190° C. and held for 2 h; in the second stage, the temperature was slowly raised to 210° C. and held for 2 h; and in the third stage, the temperature was slowly raised to 230° C. and held for 2 h, thus obtaining a thermosetting resin formed by thermal crosslinking of the OP₀B₄T₄-POSS, denoted as c-OP₀B₄T₄.

### Comparative Example 5: Bismaleimide Resin c-BMI

4 g of commercial diphenylmethane-type bismaleimide and 3 g of diallylbisphenol A were mixed and prepolymerized at 120° C. for 2 h to form a homogeneous transparent prepolymer. Subsequently, the prepolymer was poured into a polytetrafluoroethylene mold and placed in a vacuum oven for degassing to remove bubbles. The temperature was then raised to 150° C., 180° C., and 220° C. sequentially, and curing was conducted at each temperature for 2 h. The resulting thermosetting resin was denoted as c-BMI.

### Comparative Example 6: Cyanate Ester Resin c-BADCy

10 g of commercial bisphenol A-type cyanate ester resin was prepolymerized at 120° C. for 1 h to form a homogeneous prepolymer. Subsequently, the prepolymer was poured into a glass mold and placed in a vacuum oven for degassing to remove bubbles. The temperature was then raised to 150° C., 180° C., and 220° C. sequentially, and curing was conducted at each temperature for 2 h, respectively, followed by curing at 240° C. for 4 h, obtaining a thermosetting resin, denoted as c-BADCy.

### Test Example 1

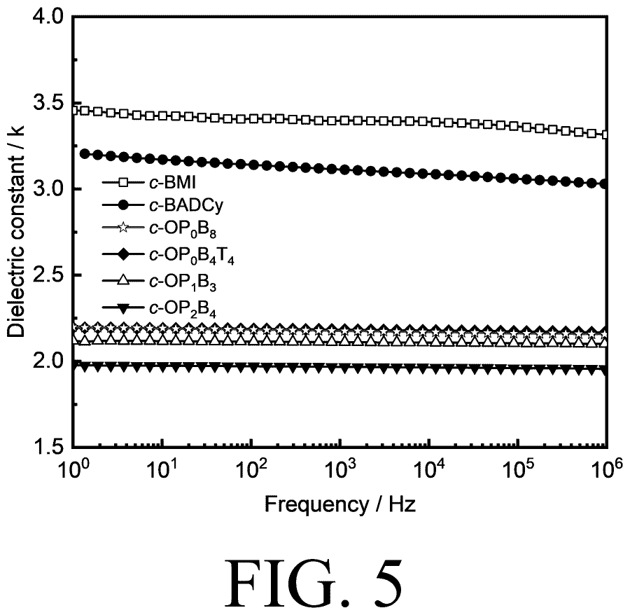

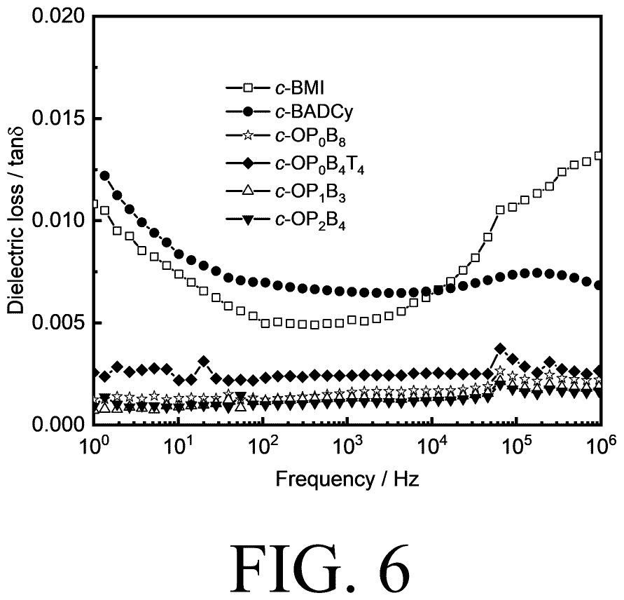

The cured materials obtained in Examples 5 to 6 and Comparative Examples 3 to 6 were tested for their dielectric constant and dielectric loss at 25° C. in a frequency range of 1 Hz to 1 MHz. The instrument used was a Concept 80 broadband dielectric spectrometer. The measurement results are shown in Table 1 and FIG. 5 to FIG. 6. Table 1 shows the dielectric properties of the open-cage benzocyclobutenyl POSS resins and the comparative resins at 1 MHz; FIG. 5 shows the broadband dielectric constant data of the open-cage benzocyclobutenyl POSS resins and the comparative example resins; and FIG. 6 shows the broadband dielectric loss data of the open-cage benzocyclobutenyl POSS resins and the comparative example resins.

TABLE 1
Dielectric properties of open-cage benzocyclobutenyl
POSS resins and comparative example resins at 1 MHz

| | Dielectric | Dielectric |
|---|---|---|
| | constant (1 MHz) | loss (1 MHz) |
| Example 5, c-OP₁B₃ | 2.10 | 0.0020 |
| Example 6, c-OP₂B₄ | 1.96 | 0.0018 |
| Comparative Example 3, c-OP₀B₈ | 2.16 | 0.0023 |
| Comparative Example 4, c-OP₀B₄T₄ | 2.17 | 0.0027 |
| Comparative Example 5, c-BMI | 3.31 | 0.013 |
| Comparative Example 6, c-BADCy | 3.03 | 0.007 |

From the above test results, it can be seen that the thermosetting resins based on open-cage benzocyclobutenyl POSS have a lower dielectric constant compared with the thermosetting resins obtained by curing those in closed-cage configurations. Furthermore, due to molecular-level homogeneous hybridization, the inventive resins do not exhibit phase separation, avoiding the interfacial polarization commonly occurring in organic-inorganic hybrid materials, and their dielectric loss remains around 2×10⁻³. Meanwhile, compared with traditional bismaleimide resins and cyanate ester resins, the inventive resins exhibit a dielectric constant as low as about 2.0 at 1 MHz, and a dielectric loss only ⅙ that of bismaleimide resins.

### Test Example 2

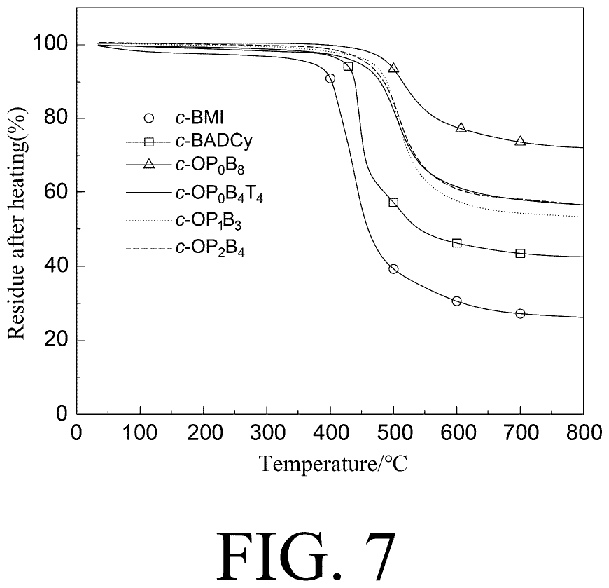

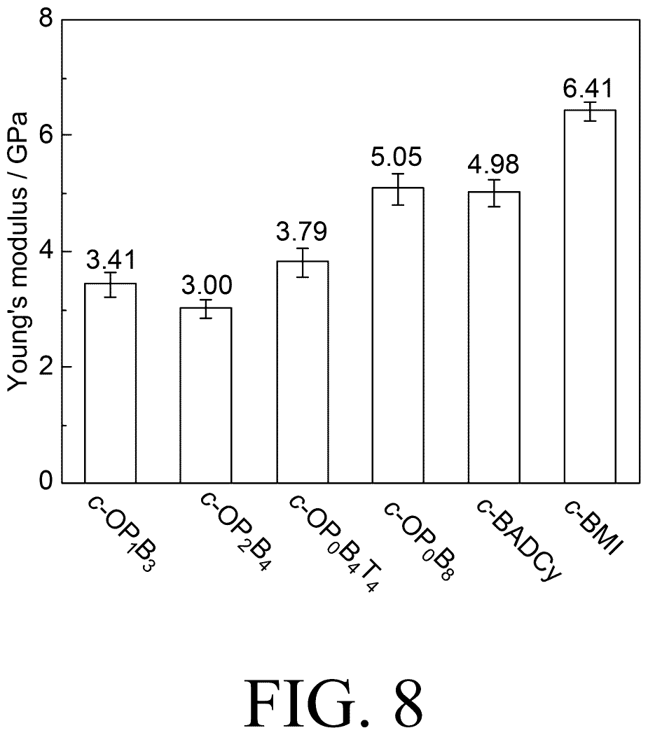

The thermogravimetric curves of the cured materials obtained in Examples 5 to 6 and Comparative Examples 3 to 6 were tested. As shown in FIG. 7, due to the presence of high surface energy and high-bond-energy Si—O bonds, the open-cage c-OP₁B₃ and c-OP₂B₄ resins exhibited better thermal stability compared with the commercial resins (c-BMI, c-BADCy). Although their thermal stability decreased compared with the more highly crosslinked closed-cage c-OP₀B₈, they exhibited high thermal stability comparable to the closed-cage resin c-OP₀B₄T₄ with a similar crosslinking degree, and their 5%-weight loss temperature remained above 450° C.

### Test Example 3

The Young's modulus of the cured materials obtained in Examples 5 to 6 and Comparative Examples 3 to 6 was tested at 25° C. using a nanoindentation testing system. The measurement results are shown in FIG. 8, indicating that the flexible open-cage structure and low functionality (3 or 4) endowed the cured products of the open-cage POSS resins with a lower Young's modulus, demonstrating their better flexibility. Therefore, they could not only be prepared into robust bulk materials by casting, but also be formed into flexible film materials (with a film thickness of about 60 m) by spin-coating or drop-coating. The closed-cage c-OP₀B₈ could only be prepared into bulk samples and it was difficult to form intact film samples; whereas the open-cage c-OP₁B₃ and c-OP₂B₄ could be prepared not only into robust bulk materials but also into flexible film materials.

In the present disclosure, the organic-inorganic thermosetting resin material prepared by thermal crosslinking of the open-cage POSS not only possesses the characteristics of an ultra-low dielectric constant (1.96) and a low dielectric loss value (around 0.002), but also exhibits a 5%-weight loss temperature reaching above 450° C. These properties are far superior to those of commercially available low-dielectric thermosetting resin materials (such as bismaleimide resins and cyanate ester resins).

Although the above embodiments have described the present disclosure in detail, it is only a part of, not all of, embodiments of the present disclosure. Other embodiments may also be obtained by persons based on embodiments in the present disclosure without creative efforts, which shall fall within the scope of the present disclosure.

What is claimed is:

1. An open-cage benzocyclobutenyl polysilsesquioxane, having a structural formula shown in formula 1 or formula 2: 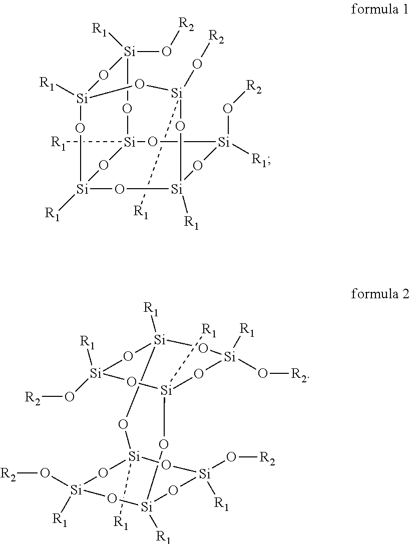
wherein in the formula 1 and the formula 2,
R₁ is selected from the group consisting of phenyl, cyclohexyl, n-pentyl, trifluoro-n-pentyl, and methyl;
R₂ is selected from the group consisting of H and 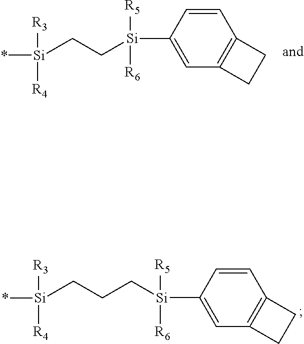
and
R₃, R₄, R₅, and R₆ each are independently selected from the group consisting of H, alkyl, cycloalkyl, cycloalkoxy, alkylthio, alkylamino, alkenylamino, aryl, heteroaryl, substituted alkyl, substituted cycloalkyl, substituted cycloalkoxy, substituted alkylthio, substituted alkylamino, substituted alkenylamino, substituted aryl, and substituted heteroaryl.

2. The open-cage benzocyclobutenyl polysilsesquioxane as claimed in claim 1, wherein for R₃, R₄, R₅, and R₆, the alkyl is C₁-C₆ alkyl; the cycloalkyl is C₃-C₆ cycloalkyl; the cycloalkoxy is 3- to 7-membered cycloalkoxy; the alkylthio is C₁-C₆ alkylthio; the alkylamino is C₁-C₆ alkylamino; the alkenylamino is C₂-C₆ alkenylamino; the aryl is C₆-C₁₂ aryl; the aryl comprises benzo C₃-C₆ cycloalkyl; and the heteroaryl is 5- to 12-membered heteroaryl, the 5- to 12-membered heteroaryl having 1 to 3 heteroatoms selected from the group consisting of N, O, and S, and the heteroaryl comprises a benzo 5- to 6-membered heterocyclic group.

3. The open-cage benzocyclobutenyl polysilsesquioxane as claimed in claim 1, wherein the open-cage benzocyclobutenyl polysilsesquioxane has a structural formula shown in formula 3 or formula 4:

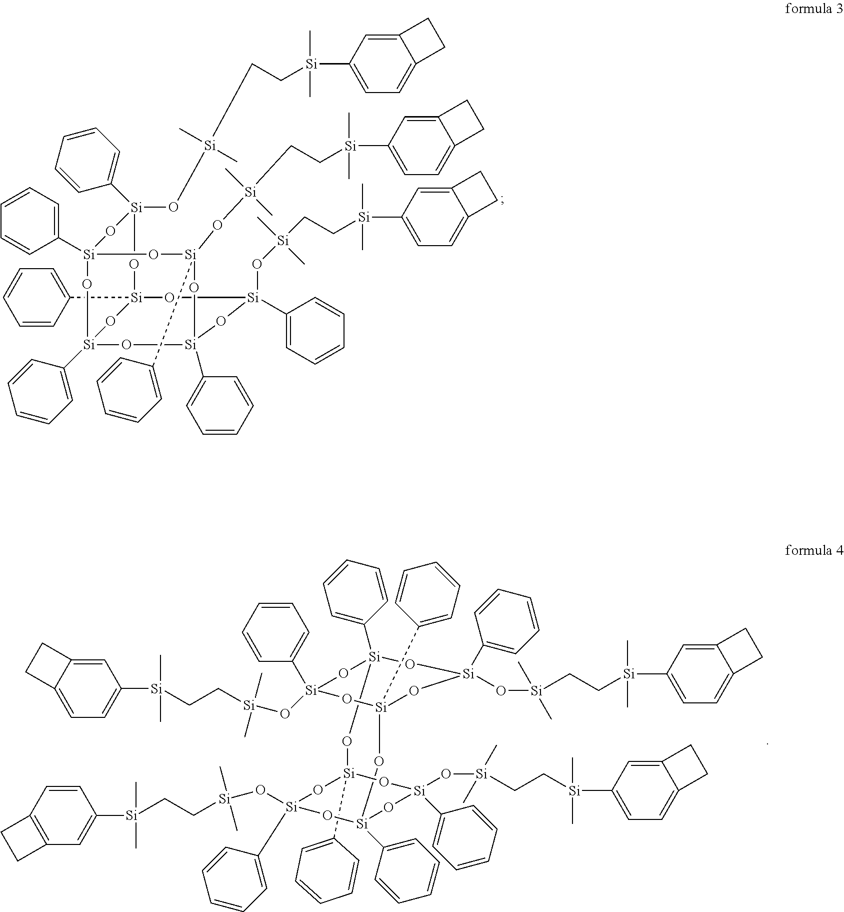

4. A method for preparing the open-cage benzocyclobutenyl polysilsesquioxane as claimed in claim 1, comprising:
mixing a trialkoxysilane coupling agent, an alkali metal hydroxide, water, and a first organic solvent, and conducting reaction under reflux to obtain an open-cage silanol alkali metal salt polysilsesquioxane;
mixing the open-cage silanol alkali metal salt polysilsesquioxane, vinyl chlorosilane, a first catalyst, and a second organic solvent, and conducting etherification to obtain a vinyl open-cage polysilsesquioxane; and
mixing the vinyl open-cage polysilsesquioxane, a benzocyclobutenyl silane compound, a second catalyst, and a third organic solvent, and conducting hydrosilylation to obtain the open-cage benzocyclobutenyl polysilsesquioxane;
wherein the trialkoxysilane coupling agent, the vinyl chlorosilane, and the benzocyclobutenyl silane compound have structural formulas shown in formula 5, formula 6 or formula 6-1, and formula 7, respectively:

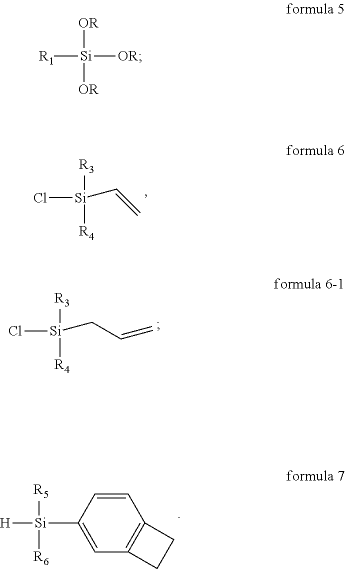

5. The method as claimed in claim 4, wherein an alkoxy in the trialkoxysilane coupling agent is selected from the group consisting of methoxy and ethoxy.

6. The method as claimed in claim 4, wherein a molar ratio of the alkali metal hydroxide to the trialkoxysilane coupling agent is in a range of 1:1.5 to 1:3.

7. The method as claimed in claim 4, wherein a molar ratio of an alkali metal element in the open-cage silanol alkali metal salt polysilsesquioxane to the vinyl chlorosilane is in a range of 1:2 to 1:4.

8. The method as claimed in claim 4, wherein a molar ratio of vinyl in the vinyl open-cage polysilsesquioxane to the benzocyclobutenyl silane compound is in a range of 1:1 to 1:1.5.

9. A cured material, wherein the cured material is obtained by crosslinking and curing the open-cage benzocyclobutenyl polysilsesquioxane as claimed in claim 1.

10. The open-cage benzocyclobutenyl polysilsesquioxane as claimed in claim 2, wherein the open-cage benzocyclobutenyl polysilsesquioxane has a structural formula shown in formula 3 or formula 4:

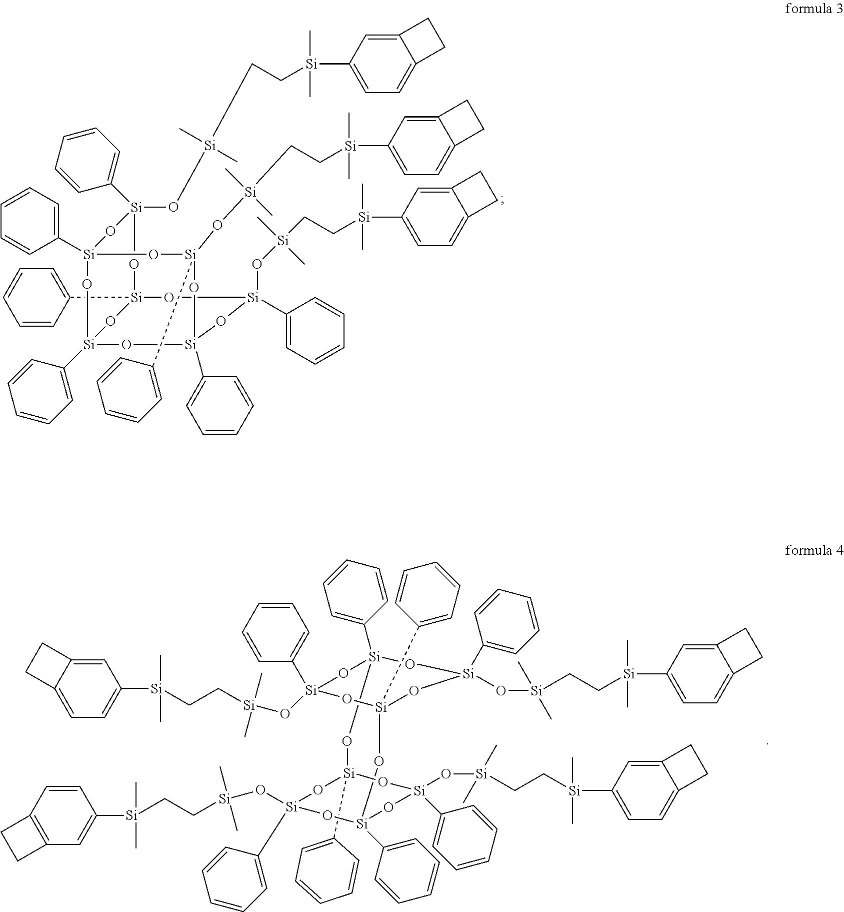

11. The method as claimed in claim 5, wherein a molar ratio of the alkali metal hydroxide to the trialkoxysilane coupling agent is in a range of 1:1.5 to 1:3.
